(19) United States
(12) Patent Application Publication
(10) Pub. No.: US 2016/0291918 A1
(43) Pub. Date: Oct. 6, 2016

(54) DISPLAY APPARATUS AND CONTROL METHOD OF DISPLAY APPARATUS

(71) Applicant: CANON KABUSHIKI KAISHA, Tokyo (JP)

(72) Inventors: Akihiko Nagano, Ichihara-shi (JP); Fumihiro Kajimura, Kawasaki-shi (JP); Kousuke Kiyamura, Kawasaki-shi (JP); Masato Shiono, Hadano-shi (JP); Shunsuke Ninomiya, Fujisawa-shi (JP); Hiromu Yasuda, Kawasaki-shi (JP); Takumi Yamanaka, Tokyo (JP); Atsushi Watanabe, Kawasaki-shi (JP)

(21) Appl. No.: 15/081,679

(22) Filed: Mar. 25, 2016

(30) Foreign Application Priority Data
Mar. 31, 2015 (JP) 2015-074496

(51) Int. Cl. G06F 3/14; G06F 3/147

(52) U.S. Cl. CPC G06F 3/1446; G06F 3/147

(57) ABSTRACT

A display apparatus with a relative layout of plurality of panels, each having a display unit includes a determining unit that determines, based on information relating to a display image to be displayed on the display units, the relative layout of the plurality of panels, and a notification unit that performs notification of the relative layout of the plurality of panels that the determining unit has determined.

### BACKGROUND

1. Field

Aspects of the present invention generally relate to a display apparatus where the relative layout of panels having display units can be changed.

2. Description of the Related Art

There are conventionally known display apparatuses where panels that each have display units are connected, and the relative layout of the panels can be changed. Japanese Patent Laid-Open No. 2013-25617 proposes an image display apparatus where an array of multiple panels each having display regions can be changed to multiple states (FIGS. 1, 4 through 8E, etc.).

### SUMMARY

An aspect of the display apparatus includes a determining unit configured to determine, based on information relating to a display image to be displayed on the display units, a relative layout of the plurality of panels, and a notification unit that performs notification of information relating to the relative layout of the plurality of panels that the determining unit has determined.

According to aspects of the present invention, ease of use can be improved for a display apparatus where the relative layout of multiple panels each having display units can be changed.

Further features of aspects of the present invention will become apparent from the following description of exemplary embodiments with reference to the attached drawings.

### BRIEF DESCRIPTION OF THE DRAWINGS

FIG. 1 is a three view plan for describing the configuration of a display apparatus which is an embodiment of a display apparatus for carrying out aspects of the present invention.

FIG. 2 is a block diagram for describing the inner configuration of the display apparatus which is an embodiment of a display apparatus for carrying out aspects of the present invention.

FIG. 3 is a four view plan for describing the configuration of a first panel making up the display apparatus which is an embodiment of a display apparatus for carrying out aspects of the present invention.

FIG. 4 is an enlarged cross-sectional view exemplarily illustrating an enlarged cross-section of groove portions on the first panel and a second panel according to an embodiment of the present invention.

FIGS. 5A through 5E are diagrams exemplarily illustrating unfolded and folded states of the display apparatus which is an embodiment of a display apparatus for carrying out aspects of the present invention.

FIGS. 6A through 6C are diagrams exemplarily describing a case of changing the state of the display apparatus, which is an embodiment of a display apparatus for carrying out aspects of the present invention, from a laterally unfolded state to a stored state A (folding).

FIGS. 7A through 7E are diagrams exemplarily describing a case of changing the state of the display apparatus, which is an embodiment of a display apparatus for carrying out the present invention, from a laterally unfolded state to a both-side state (folding).

FIGS. 8A through 8E are diagrams exemplarily describing a case of changing the state of the display apparatus, which is an embodiment of a display apparatus for carrying out aspects of the present invention, from a longitudinally unfolded state to a both-side state (folding).

FIG. 9 is a diagram for describing a digital camera according to an embodiment of the present invention (rear view).

FIG. 10 is a block diagram for describing the internal configuration of a camera body according to an embodiment of the present invention.

FIGS. 11A through 11D are diagrams for describing states of the digital camera according to an embodiment of the present invention, and the positional relationship among electric contacts of the display apparatus.

FIG. 12 is a diagram for describing states of the digital camera according to an embodiment of the present invention, and conduction states among the electric contacts.

FIG. 13 is a flowchart for describing state notification processing of the digital camera according to an embodiment of the present invention.

FIGS. 14A through 14C are diagrams exemplarily illustrating display of a notification image relating to the laterally unfolded state of the display apparatus and audio guidance, in state notification processing according to an embodiment of the present invention.

FIGS. 15A through 15C are diagrams exemplarily illustrating display of a notification image relating to the longitudinal unfolded state of the display apparatus and audio guidance, in state notification processing according to an embodiment of the present invention.

FIG. 16 is a flowchart for describing state notification processing in a shooting mode of the digital camera according to an embodiment of the present invention.

FIG. 17 is a diagram for describing a method of determining a notification state in the shooting mode of the digital camera according to an embodiment of the present invention.

FIGS. 18A through 18D are diagrams illustrating a display apparatus according to an embodiment of aspects of the present invention.

### DESCRIPTION OF THE EMBODIMENTS

### Embodiment

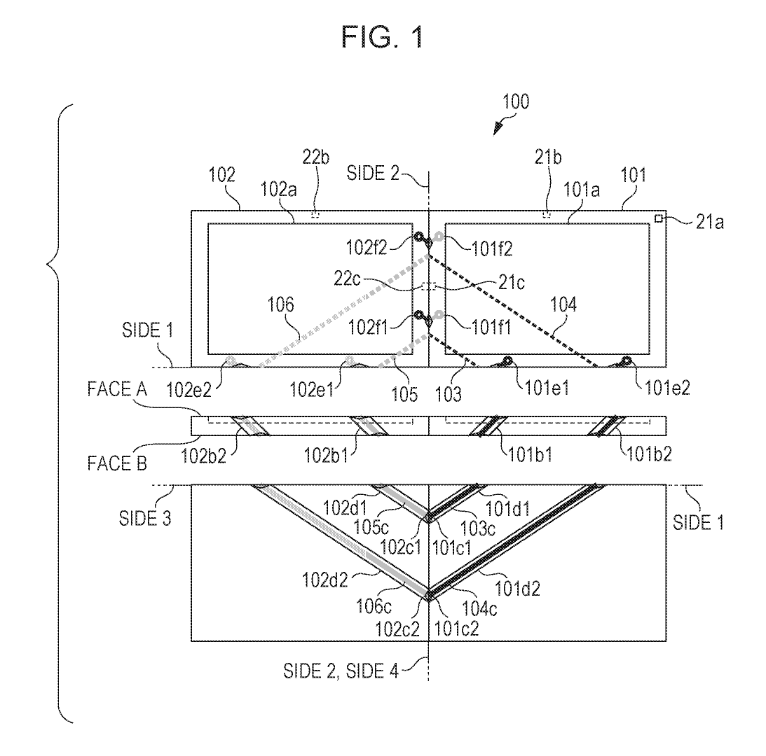

An exemplary embodiment of the present invention will be described in detail with reference to the attached drawings. First, the configuration of a display apparatus 100 that is a display apparatus according to the present embodiment will be described with reference to FIGS. 1 through 8E. FIG. 1 is a three view plan for describing the configuration of display apparatus 100 which is an embodiment of a display apparatus for carrying out aspects of the present invention, illustrating a frontal view, lower view (bottom view), and rear view of the display apparatus 100. The display apparatus 100 according to the present embodiment is configured including a first panel (first housing) 101 and a second panel (second housing) 102 which are plate-shaped cuboids.

The first panel 101 has a first display unit 101a, and the second panel 102 has a second display unit 102a. The first display unit 101a and the second display unit 102a both are rectangular in shape, with the lengths of orthogonal sides being different. In the present embodiment, the first display unit 101a and second display unit 102a are notification units that notify the user of a state of the display apparatus 100 that is suitable for a display image which will be described later.

The present embodiment has a configuration where a thin-film transistor (TFT) driven liquid crystal display (LCD) device is employed for each display unit. Alternatively, organic electroluminescence (EL) devices or the like may be used as the display units. Display of the first display unit 101a and the second display unit 102a is controlled by a first display control circuit 110 and a second display control circuit 120 which will be described later. In a later-described digital camera 1 (hereinafter referred to simply as “camera”), display at the first display unit 101a and the second display unit 102a is controlled through the first display control circuit 110 and the second display control circuit 120 in accordance with instructions from a camera microprocessor 2.

A face A provided on the first display unit 101a of the first panel 101 serves as the front face (first face), and a face B on the opposite side serves as a rear face (third face), as illustrated in FIG. 1. A face of the first panel 101 where a later-described groove portion 101c1 and groove portion 101c2 are provided serves as a left-side face, and the face on the opposite side thereof serves as a right-side face. A face of the first panel 101 where a later-described groove portion 101b1 and groove portion 101b2 are provided serves as a lower-side face, and the face on the opposite side thereof serves as an upper-side face.

The long side of the first panel 101 on the lower-side face as viewed from the first display unit 101a side serves as side 1 (first side), and the short side of the first panel 101 on the right-side face serves as side 2 (second side). Side 1 and side 2 meet at right angles. The term “orthogonal” for the angle between side 1 and side 2 is 90 degrees±2 degrees.

A face A provided on the second display unit 102a of the second panel 102 serves as the front face (second face), and a face B on the opposite side serves as a rear face (fourth face). A face of the second panel 102 where a later-described groove portion 102c1 and groove portion 102c2 are provided serves as a right-side face, and the face on the opposite side thereof serves as a left-side face. A face of the second panel 102 where a later-described groove portion 102b1 and groove portion 102b2 are provided serves as a lower-side face, and the face on the opposite side thereof serves as an upper-side face.

The long side of the second panel 102 on the lower-side face as viewed from the second display unit 102a side serves as side 3 (third side), and the short side of the second panel 102 on the left-side face serves as side 4 (fourth side). Side 3 and side 4 meet at right angles. The term “orthogonal” for the angle between side 3 and side 4 means 90 degrees±2 degrees.

The display apparatus 100 is a display apparatus which can be changed to various states, by changing the relative layout of the first panel 101 and the second panel 102. A state of the display apparatus 100 where the first display unit 101a and the second display unit 102a are facing generally in the same direction is the unfolded state. That is to say, a state in which face A (or face B) of both the first panel 101 and the second panel 102 are facing generally in the same direction is the unfolded state of the display apparatus 100.

The term “facing in the same direction” for the angle between the face A (or face B) of both the first panel 101 and the second panel 102 means 180 degrees±10 degrees in side view of the display apparatus 100.

Of multiple unfolded states which the display apparatus 100 described above can assume, an unfolded state in which the left side face of the first panel 101 and the right side face of the second panel 102 come into contact will be referred to as a lateral unfolded state (first state). an unfolded state of the display apparatus 100 in which the lower side face of the first panel 101 and the upper side face of the second panel 102 come into contact will be referred to as a longitudinal unfolded state (second state).

That is to say, in the lateral unfolded state of the display apparatus 100, the side 2 of the first panel 101 and the side 4 of the second panel 102 are in contact. In the longitudinal unfolded state of the display apparatus 100, the side 1 of the first panel 101 and the side 3 of the second panel 102 are mutually adjacent.

A state in which the side 3 of the second panel 102 exists on an extended line of the side 1 of the first panel 101 is the lateral unfolded state of the display apparatus 100 according to the present embodiment. A state in which the side 4 of the second panel 102 exists on an extended line of the side 2 of the first panel 101 is the longitudinal unfolded state of the display apparatus 100.

A state of the display apparatus 100 in which the face A of both the first panel 101 and the second panel 102 face each other and the face B of both face opposite directions serves as the stored state. That is to say, a state where the first display unit 101a of the first panel 101 and the second display unit 102a of the second panel 102 face each other (an opposing state) is the stored state of the display apparatus 100.

The display apparatus 100 can be changed between two stored states, a stored state A and a stored state B. Groove portions through which wires are led in the first panel 101 and second panel 102, which will be described later, differ depending on the stored states A and B, described earlier. This will be described later in detail.

A state of the display apparatus 100 in which the face B of both the first panel 101 and the second panel 102 face each other and the face A of both face opposite directions serves as a both-sided state. That is to say, a state where the first display unit 101a of the first panel 101 and the second display unit 102a of the second panel 102 are exposed and facing in opposite directions is the both-sided state of the display apparatus 100.

A state of the display apparatus 100 during transition from the unfolded state to the stored state, or from the unfolded state to the both-sided state, which has been described above, is the “transitional state” of the display apparatus 100.

Note that in the stored state and both-sided state of the display apparatus 100, the side 1 of the first panel 101 and the side 3 of the second panel 102 are overlaid (generally match) in view of the display apparatus 100 from a direction orthogonal to the display screens of the display units. In the stored state and both-sided state of the display apparatus 100, the side 2 of the first panel 101 and the side 4 of the second panel 102 are overlaid (generally match) in view of the display apparatus 100 from a direction orthogonal to the display screens of the display units.

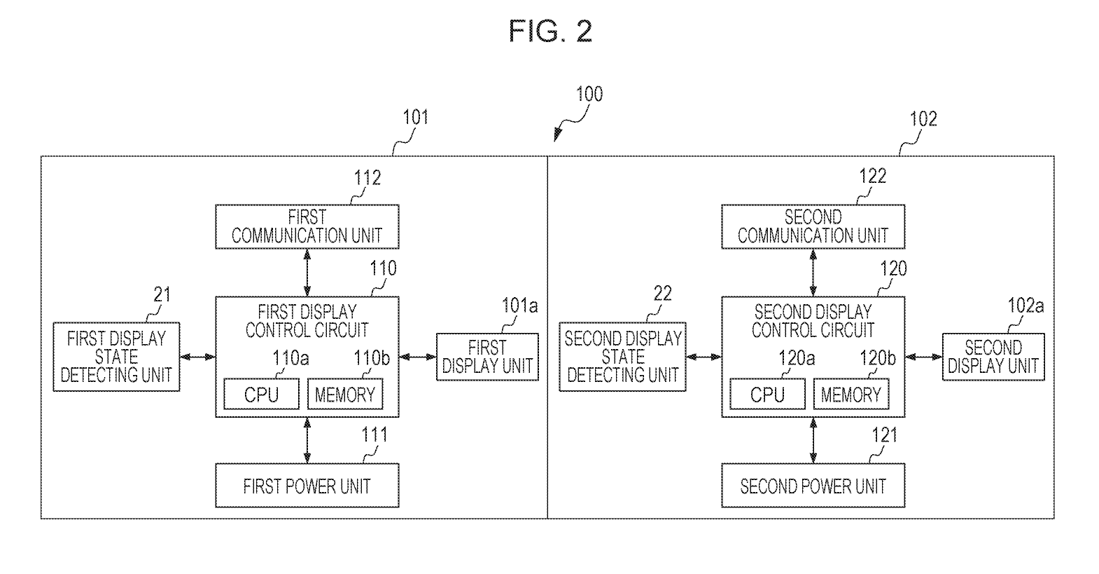

The internal configuration of the display apparatus 100 will next be described with reference to FIG. 2. FIG. 2 is a block diagram for describing the inner configuration of the display apparatus 100 which is an embodiment of a display apparatus for carrying out aspects of the present invention. The first panel 101 includes the first display control circuit 110, a first power unit 111, a first communication unit 112, a first display state detecting unit 21, and the first display unit 101a. The second panel 102 includes the second display control circuit 120, a second power unit 121, a second communication unit 122, a second display state detecting unit 22, and the second display unit 102a.

The first display control circuit 110 is a display controller that can control display images to be displayed on the first display unit 101a. Provided inside the first display control circuit 110 is a first microprocessor (first central processing unit (CPU)) for the first display unit 101a, and first memory 110b. The second display control circuit 120 is a display controller that can control display images to be displayed on the second display unit 102a. Provided inside the second display control circuit 120 is a second microprocessor (second CPU) for the second display unit 102a, and second memory 120b. The first memory 110b and second memory 120b are memory capable of electrically-erasable storage, such as electrically erasable programmable read-only memory (EEPROM) of which flash memory and the like is representative, for example. Each memory stores various types of data used by the display apparatus 100 according to the present embodiment.

A display image according to the present embodiment is an image to be displayed on the display apparatus 100 or an image that is being displayed on the display apparatus 100. For example, in a case where a single image is to be divided and displayed separately on the first display unit 101a and the second display unit 102a, both the original image before dividing, and the image after dividing, are display images.

The first power unit 111 is an electric power supply unit that supplies electric power to within the first panel 101. The second power unit 121 is an electric power supply unit that supplies electric power to within the second panel 102. Upon an unshown power supply of the display apparatus 100 being turned on, electric power is supplied to the parts within the first panel 101 from the first power unit 111 via the first display control circuit 110. In the same way, electric power is supplied to the parts within the second panel 102 from the second power unit 121 via the second display control circuit 120.

The first communication unit 112 and second communication unit 122 are communication units, to exchange various types of data between the first panel 101 and the second panel 102 in accordance with instructions from the first display control circuit 110 and the second display control circuit 120.

The first communication unit 112 and the second communication unit 122 according to the present embodiment are configured to exchange information (display signals) relating to display images to be displayed on the display units, by wireless communication. Accordingly, the first display unit 101a and second display unit 102a can display different images or images where a single image has been divided, by exchanging such display signals between the first panel 101 and the second panel 102.

The first communication unit 112 and second communication unit 122 are also communicable with a camera communication unit 7 provided in a camera body 10 making up the camera 1 described later. Central control of operations of the display apparatus 100 is governed by the camera microprocessor 2 provided to the camera 1. This will be described later in detail.

The display state detecting unit (first display state detecting unit) 21 is a detecting unit made up of electric contacts 21a, 21b, and 21c. The electric contact 21a is provided at a position on face A of the first panel 101 that does not overlay the first display unit 101a (i.e., on the edge portion of face A). The electric contact 21b is disposed on the inside of the upper face of the first panel 101. The electric contact 21c is disposed on the inside of the left side face of the first panel 101.

The display state detecting unit (second display state detecting unit) 22 is a detecting unit made up of electric contacts 22b and 22c. The electric contact 22b is disposed on the inside of the upper face of the second panel 102. The electric contact 22c is disposed on the inside of the right side face of the second panel 102.

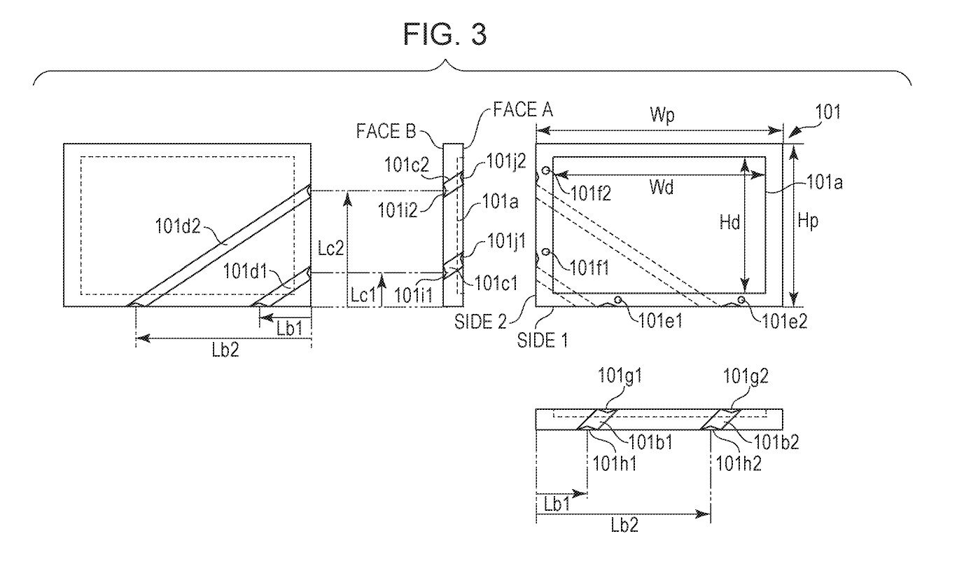

Details of the positions where the above-described electric contacts are disposed will be described later along with description of a camera state detecting unit 20 and electric contact 20a. The electric contacts are omitted from illustration in FIGS. 3 and 5 through 8E, to simplify description.

The state of the display apparatus 100 can be detected in the present embodiment by detecting the conduction state between the electric contact 21b and the electric contact 22b, and the conduction state between the electric contact 21c and the electric contact 22c. Specifically, in a case where a conducting state is detected between the electric contact 21b and the electric contact 22b, determination (detection) is made that the state of the display apparatus 100 is the lateral unfolded state. In a case where a conducting state is detected between the electric contact 21c and the electric contact 22c, determination (detection) is made that the state of the display apparatus 100 is the longitudinal unfolded state.

The detection results (output signals) of the first display state detecting unit 21 and second display state detecting unit 22 are transmitted from the display apparatus 100 to the camera 1 side via the first communication unit 112 or second communication unit 122 of the display apparatus 100 and the camera communication unit 7 of the camera 1.

Note that in the present embodiment, a configuration is described where the state of the display apparatus 100 (and state of the camera 1) is determined by the camera microprocessor 2 provided to the later-described camera body 10, but an arrangement may be made where this determination is made at the display apparatus 100 side. Specifically, a configuration may be made where the first display control circuit 110 (first CPU 110a) or second display control circuit 120 (second CPU 120a) determines (detects) the state of the display apparatus 100 based on the detection results of the first display state detecting unit 21 and second display state detecting unit 22. This configuration is used in particular when using the display apparatus 100 standalone.

While the display apparatus 100 is described in the present embodiment as having display control circuits and the like in both the first panel 101 and the second panel 102, this is not restrictive. For example, an arrangement may be made where a display control circuit is provided in just one of the first panel 101 and second panel 102. In this case, the display control circuit provided to the one panel centrally controls both the first panel 101 and the second panel 102.

While the display apparatus 100 is described in the present embodiment as having a configuration where communication is performed among the panels by wireless communication, this is not restrictive. For example, a configuration may be made where a communication cable or the like is provided within the later-described wires serving as connecting members to connect the first panel 101 and the second panel 102, so as to perform communication among the panels using this communication cable. In this case, the later-described camera body 10 and display apparatus 100 are electrically connected by the communication cable.

Next, the first panel 101 will be described in detail with reference to FIG. 3. Although the right-side face of the first panel 101 has a configuration of being connected by a hinge 14 that connects the later-described camera 1 and display apparatus 100, details thereof will be described later to simplify the description of the display apparatus 100.

FIG. 3 is a four view plan of the first panel 101 making up the display apparatus 100 which is an embodiment of a display apparatus for carrying out aspects of the present invention, and illustrates a frontal view, left side view, lower view (bottom view), and rear view.

The first panel 101 satisfies the relationship of Expression (1)

Wp>Hp,Wd>Hd (1)

where Wp represents the length of side 1, Hp represents the length of side 2, Wd represents the length of a side of the first display unit 101a that is parallel to side 1 (horizontal width), and Hd represents the length of a side of the first display unit 101a that is parallel to side 2 (vertical width).

That is to say, the length Wp of the sides of the first panel 101 in the longitudinal direction is larger than the length Hp of the sides of the first panel 101 in the shorter side direction. The length Wd of the sides of the first display unit 101a in the longitudinal direction is larger than the length Hd of the sides of the first display unit 101a in the shorter side direction. The first panel 101 according to the present embodiment satisfies the relationship of Expression (2).

Wp:Hd=3:2 (2)

For the aspect ratio, which is the ratio between Wd and Hd of the first panel 101, the present embodiments employs a ratio primarily used in photography, as can be seen from Expression (2), but this is not restrictive, and other ratios may be used.

The first panel 101 according to the present embodiment has the first display unit 101a positioned so that the center of the first panel 101 and the center of the first display unit 101a generally agree. In this state, the width of the frame of the first panel 101 (the distance from the edge of the first display unit 101a to the edge of the first panel 101) is one-tenth the distance of the length Wd of the first display unit 101a in the longitudinal direction and the length Hd in the shorter side direction or less. Due to this configuration, the distance between the first display unit 101a and the second display unit 102a can be minimized when the display apparatus 100 is in the unfolded state. Accordingly, in a case where a single image (display image) is divided and displayed separately in the first display unit 101a and second display unit 102a, the user of the display apparatus 100 according to the present embodiment viewing this single image can see the image in a natural manner.

To avoid the user from sensing the image viewed on the display apparatus 100 as being unnatural, the width of the frame of the first panel 101 is preferably minimized. Accordingly, a configuration may be made where the position of the first display unit 101a is shifted from the center of the first panel 101 toward later-described groove portions 101c1, 101c2, 101d1, and 101d2. According to this configuration, the first display unit 101a and second display unit 102a can be brought closer to each other when the display apparatus 100 is in the unfolded state, so the user viewing the image can see the image in a natural manner.

The first panel 101 has linear groove portions passing from the front face (face A) across the lower side face (side face on side 1) and extending to the rear face (face B), as illustrated in FIG. 3. Of the groove portions, the groove portion provided on the lower side face of the first panel 101 is the groove portion 101b1 and groove portion 101b2. The groove portion provided on the face B of the first panel 101 is the groove portion 101d1 and groove portion 101d2. Further, the groove portion provided on the left side face of the first panel 101 is the groove portion 101c1 and groove portion 101c2.

As can be seen from FIG. 3, on side 1 of the first panel 101 according to the present embodiment, the positions of the end portion of the groove portion 101d1 at the lower-side face and the end portion of the groove portion 101b1 at the lower-side face agree. Also, on side 2 of the first panel 101, the positions of the end portion of the groove portion 101d1 at the left-side face and the end portion of the groove portion 101c1 at the left-side face agree. That is to say, a consecutive series of groove portions is formed on the first panel 101 by the groove portion 101b1, groove portion 101d1, and groove portion 101c1.

In the same way, on side 1 of the first panel 101, the positions of the end portion of the groove portion 101d2 at the lower-side face and the end portion of the groove portion 101b2 at the lower-side face agree, and on side 2 the positions of the end portion of the groove portion 101d2 at the left-side face and the end portion of the groove portion 101c2 at the left-side face agree. That is to say, a consecutive series of groove portions is formed on the first panel 101 by the groove portion 101b2, groove portion 101d2, and groove portion 101c2.

Now, corners formed at the side 1 on the first panel 101 by the face A and the lower-side face generally orthogonally meeting are corners 101g1 and 101g2. Corners formed at the side 1 on the first panel 101 by the lower-side face and face B generally orthogonally meeting are corners 101h1 and 101h2. Also, corners formed at the side 2 on the first panel 101 by face B and the left-side face generally orthogonally meeting are corners 101i1 and 101i2. Further, corners formed at the side 2 on the first panel 101 by the left-side face and face A generally orthogonally meeting are corners 101j1 and 101j2.

Of these, the corners 101g1, 101h1, 101i1, and 101j1, are corners formed included in the continuously formed groove portions 101b1, groove portion 101c1, and groove portion 101d1. Also, the corners 101g2, 101h2, 101i2, and 101j2, are corners formed included in the continuously formed groove portions 101b2, groove portion 101c2, and groove portion 101d2.

Grooves groove portion 102b1 through groove portion 102d2 are also formed on the face of the second panel 102, in the same way as the above-described first panel 101. A series of continuous grooves are formed of the groove portion 102b1, groove portion 102c1, and groove portion 102d1, and the groove portion 102b2, groove portion 102c2, and groove portion 102d1. The groove portions on the second panel 102 are formed at positions corresponding to the positions of the groove portions formed on the first panel 101 as described above. This will be described in detail later.

A series of groove portions is also formed from the above-described groove portions on the front face (face A) of the first panel 101 and second panel 102. The groove portions on the face A are groove portions formed toward later-described fixing portions provided on the panels, provided so that wires guided to the front face of the panels do not protrude from the exterior of the panels.

The groove portion 101b1 and groove portion 101d1 are formed on the lower-side face and face B of the first panel 101 at positions distanced from the side 2 by a distance Lb1. The groove portion 101b2 and groove portion 101d2 are formed on the lower-side face and face B of the first panel 101 at positions distanced from the side 2 by a distance Lb2. The groove portion 101c1 is formed on the left-side face (side face at side 2) of the first panel 101 at a position distanced from the side 1 by a distance Lc1. The groove portion 101c2 is formed on the left-side face (side face at side 2) of the first panel 101 at a position distanced from the side 1 by a distance Lc2. Note that distance Lb2 is larger than distance Lb1, and that distance Lc2 is larger than distance Lc1.

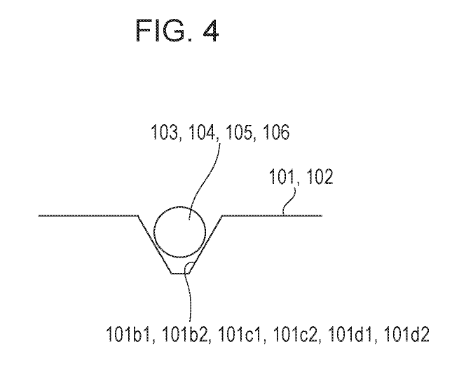

FIG. 4 is an enlarged cross-sectional view exemplarily illustrating an enlarged cross-section of a groove on the first panel 101 and second panel 102 according to an embodiment of the present invention. The groove portions described above, which are formed on the first panel 101 and second panel 102, are like that illustrated in FIG. 4. The groove portions are formed having a V-shaped cross-sectional form on the panels.

In a state where the ends of the later-described wires are fixed at later-described fixing portions, the wires are guided through the groove portions formed on the surface of the first panel 101 and second panel 102. The wires fall into the grooves through which they are guided, as illustrated in FIG. 4. The wires will be described in detail later.

The fixing portions provided to the first panel 101 will be described next. A fixing portion 101e1, fixing portion 101e2, fixing portion 101f1, and fixing portion 101f2 are provided on the frame on face A of the first panel 101 at positions that do not overlap with the first display unit 101a, as illustrated in FIG. 3. The fixing portion 101e1 is a fixing member to fix one end of a later-described wire 103. The fixing portion 101e2 is a fixing member to fix one end of a later-described wire 104. The fixing portion 101f1 is a fixing member to fix one end of a later-described wire 105. The fixing portion 101f2 is a fixing member to fix one end of a later-described wire 106.

The fixing portion 101e1 and fixing portion 101e2 are provided at a position (first position) of the frame portion on face A of the first panel 101, in the neighborhood of the lower-side face (first side). The fixing portion 101f1 and fixing portion 101f2 are provided at a position (fourth position) of the frame portion on face A of the first panel 101, in the neighborhood of the left-side face (second side).

The first panel 101 has been described so far; next, the second panel 102 will be described in detail. Note that the configuration of the second panel 102 is generally the same as that of the first panel 101 described above, so only the differences between the second panel 102 and the first panel 101 will be described below.

On side 3 of the second panel 102 according to the present embodiment, the positions of the end portion of the groove portion 102d1 at the lower-side face and the end portion of the groove portion 102b1 at the lower-side face agree, and on side 4 of the second panel 102, the positions of the end portion of the groove portion 102d1 at the right-side face and the end portion of the groove portion 102c1 at the right-side face agree. That is to say, a consecutive series of groove portions is formed on the second panel 102 by the groove portion 102b1, groove portion 102d1, and groove portion 102c1. In the same way, on side 3 of the second panel 102, the positions of the end portion of the groove portion 102d2 at the lower-side face and the end portion of the groove portion 102b2 at the lower-side face agree, and on side 4 the positions of the end portion of the groove portion 102d2 at the right-side face and the end portion of the groove portion 102c2 at the right-side face agree. That is to say, a consecutive series of groove portions is formed on the second panel 102 by the groove portion 102b2, groove portion 102d2, and groove portion 102c2.

In the same way as the first panel 101 described above, the second panel 102 also has formed therein corners 102g1, 102g2, 102h1, 102h2, 102i1, 102i2, 102j1, and 102j2. Corners formed at the side 3 on the second panel 102 by the face A and the lower-side face generally orthogonally meeting are corners 102g1 and 102g2. Corners formed at the side 3 on the second panel 102 by the lower-side face and face B generally orthogonally meeting are corners 102h1 and 102h2. Corners formed at the side 4 on the first panel 101 by face B and the right-side face generally orthogonally meeting are corners 102i1 and 102i2. Corners formed at the side 4 on the second panel 102 by the right-side face and face A generally orthogonally meeting are corners 102j1 and 102j2. Of these, the corners 102g1, 102h1, 102i1, and 102j1, are corners formed included in the continuously formed groove portions 102b1, groove portion 102c1, and groove portion 102d1. Also, the corners 102g2, 102h2, 102i2, and 102j2, are corners formed included in the continuously formed groove portions 102b2, groove portion 102c2, and groove portion 102d2.

A fixing portion 102e1, fixing portion 102e2, fixing portion 102f1, and fixing portion 102f2 are provided on the frame on face A of the first panel 102 at positions that do not overlap with the second display unit 102a. The fixing portion 102e1 is a fixing member to fix one end of the later-described wire 105. The fixing portion 102e2 is a fixing member to fix one end of the later-described wire 106. The fixing portion 102f1 is a fixing member to fix one end of the later-described wire 103. The fixing portion 102f2 is a fixing member to fix one end of the later-described wire 104.

The fixing portion 102e1 and fixing portion 102e2 are provided at a position (third position) of the frame portion on face A of the second panel 102, in the neighborhood of the lower-side face (third side). The fixing portion 102f1 and fixing portion 102f2 are provided at a position (second position) of the frame portion on face A of the second panel 102, in the neighborhood of the right-side face (fourth side). This so far has been a description of the second panel 102.

Next, the wires 103 through 106, which are connecting members enabling the relative layout of the first panel 101 and second panel 102 to be changed in the present embodiment, will be described in detail. The wires 103 through 106 are linear connecting members formed of synthetic fiber or metal material, connecting the first panel 101 and the second panel 102 so that the first panel 101 and second panel 102 can be folded.

The wires 103 through 106 each have elasticity in the linear direction, and flexibility in the bending direction. Both ends of each wire are not connected to each other, so the wires are linear connecting members. In other words, the wires 103 through 106 in the present embodiment have a non-loop shape.

The above-described wires 103 through 106 are fixed to the fixing portions with both ends in a pulled state, so that tension occurs in the linear direction of each wire. For example, in the case of the wire 103, the wire 103 is fixed to the fixing portion 101e1 and the fixing portion 102f1 so that there is no sagging thereof in both the unfolded state and folded state (whether the stored state or both-sided state) of the display apparatus 100. Due to this configuration, the wires 103 through 106 trace a path that is the shortest in the state of having been guided through their respective groove portions.

The wires 103 through 106 are subjected to external force when the user changes the state (unfolds or folds) of the display apparatus 100. The tension of the wires is preferably increased to reduce slack in the wire, in order to prevent the wires from coming out of the groove portions. Specifically, the tension of the wire is preferably reduced to a predetermined value or lower, this predetermined value being calculated from the tensile strength of the wire. That is to say, the tension of the wires needs to be within a desirable range in order to ensure reliability, taking into consideration the risk of wires coming out of the grooves, damage to the wires, and so forth. However, the tension of the wires vary from the designed values due to machine precision of parts and assembly precision.

Accordingly, the fixing portions of the display apparatus 100 according to the present embodiment each have tension adjusting mechanisms capable of adjusting the tension of the corresponding wires. Further, the wires 103 through 106 each are fixed to different fixing portions, each of which is an independent part.

An example of the aforementioned tension adjusting mechanisms is as follows. Holes into which the wires can be inserted are provided at each position on the first panel 101 and the second panel 102 corresponding to the aforementioned fixing portions. In a state where the wires are inserted into the holes, fixing pins are inserted into the holes to fix the ends of the wires. According to this configuration, the tension of a wire can be adjusted by changing the amount of wire inserted into the hole and the degree of insertion of the pin. In this case, the fixing portions serve as the tension adjusting mechanisms.

The outer diameter of the aforementioned fixing pins is set so as to be slightly larger than the inner diameter of the holes. Thus, the inside of the holes and the outside of the fixing pins slide over each other with a predetermined amount of friction force is the fixing pin can be prevented from falling out from the hole.

According to the above-described configuration, tension of the wires of the display apparatus 100 according to the present embodiment can be adjusted independently. Thus, wires coming out of the corresponding grooves, and damage to the wires, can be prevented.

Note that even if the tension of the wire 103 is adjusted using the tension adjusting mechanism of the fixing portion 101e1, this does not change the tension of the other wires 104 through 106. Accordingly, the display apparatus 100 according to the present embodiment can independently adjust only wires that need adjustment. This so far has been description of the wires 103 through 106.

In a case where the display apparatus 100 is in the lateral unfolded state, the positions of the groove portions and the fixing portions provided to the first panel 101 and the second panel 102 are in a linearly symmetrical relationship with side 2 and side 4 serving as the center line. Also, in a case where the display apparatus 100 is in the longitudinal unfolded state, the positions of the groove portions and the fixing portions provided to the first panel 101 and the second panel 102 are in a linearly symmetrical relationship with side 1 and side 3 serving as the center line. This will be described in detail later.

There are various other methods for fixing the corresponding wires by the fixing portions in the display apparatus 100 according to the present embodiment, besides the above-described fixing pins, including adhesion, fusing, crimping, hooking on hooks, and so forth.

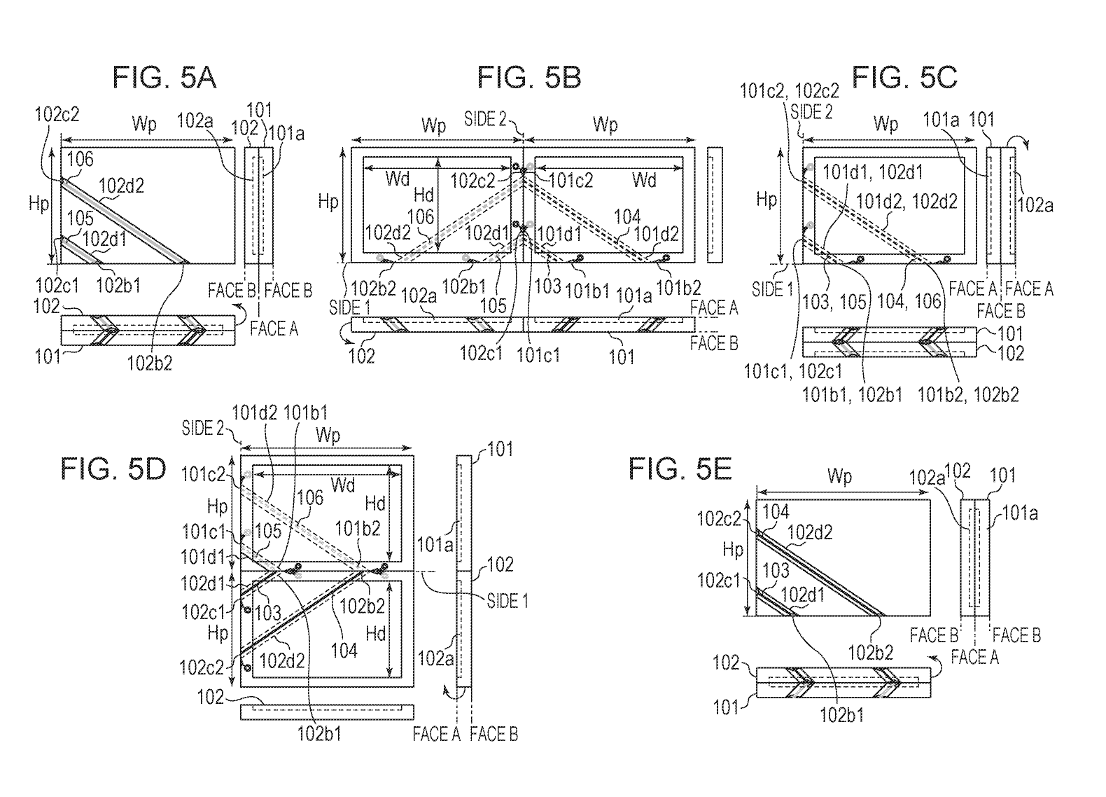

Next, unfolded states and folded states of the display apparatus 100 will be described with reference to FIGS. 5A through 5E. FIGS. 5A through 5E are diagrams exemplarily illustrating unfolded states and folded states of the display apparatus 100 which is an embodiment of a display apparatus for carrying out aspects of the present invention. FIGS. 5A through 5E show a three view plan (frontal view, right side view, and lower view) of the display apparatus 100 in various states. FIG. 5A is a diagram exemplarily illustrating the stored state A of the display apparatus 100.

In the stored state A of the display apparatus 100, the positions of side 1 of the first panel 101 and side 3 of the second panel 102 agree, and the positions of side 2 of the first panel 101 and side 4 of the second panel 102 agree, in the direction orthogonal to face A and face B of the panels.

FIG. 5B is a diagram exemplarily illustrating the lateral unfolded state of the display apparatus 100, illustrating a state in which the second panel 102 has been turned generally 180 degrees relative to the first panel 101 in the direction of the arrow illustrated in FIG. 5A (unfolded). In the lateral unfolded state, side 3 of the second panel 102 exists on an extended line of side 1 of the first panel 101, with face A and face B of the first panel 101 and the second panel 102 each facing the same direction.

FIG. 5C is a diagram exemplarily illustrating the both-sided state of the display apparatus 100, illustrating a state in which the second panel 102 has been turned generally 180 degrees relative to the first panel 101 in the direction of the arrow illustrated in FIG. 5B (folded). In the both-sided state, the positions of side 1 of the first panel 101 and side 3 of the second panel 102 agree, and the positions of side 2 of the first panel 101 and side 4 of the second panel 102 agree, in the direction orthogonal to face A and face B of the panels, which is the same as the stored state A.

FIG. 5D is a diagram exemplarily illustrating the longitudinal unfolded state of the display apparatus 100, illustrating a state in which the second panel 102 has been turned generally 180 degrees relative to the first panel 101 in the direction of the arrow illustrated in FIG. 5C (unfolded). In the longitudinal unfolded state, side 4 of the second panel 102 exists on an extended line of side 2 of the first panel 101, with face A and face B of the first panel 101 and the second panel 102 each facing the same direction.

FIG. 5E is a diagram exemplarily illustrating the stored state B of the display apparatus 100, illustrating a state in which the second panel 102 has been turned generally 180 degrees relative to the first panel 101 in the direction of the arrow illustrated in FIG. 5D (folded). In the stored state B, the positions of side 1 of the first panel 101 and side 3 of the second panel 102 agree, and the positions of side 2 of the first panel 101 and side 4 of the second panel 102 agree, in the direction orthogonal to face A and face B of the panels, which is the same as the stored state A.

The positions of the wires in each of the states of the display apparatus 100 (the relative positions of the panels) will be described in detail with reference to FIGS. 5A through 5E. One end of the wire (first connecting member) 103 is fixed to the fixing portion 101e1 of the first panel 101, and the other end is fixed to the fixing portion 102f1 of the second panel 102. One end of the wire (first connecting member) 104 is fixed to the fixing portion 101e2 of the first panel 101, and the other end is fixed to the fixing portion 102f2 of the second panel 102. Also, one end of the wire (second connecting member) 105 is fixed to the fixing portion 102e1 of the second panel 102, and the other end is fixed to the fixing portion 101f1 of the first panel 101. One end of the wire (second connecting member) 106 is fixed to the fixing portion 102e2 of the second panel 102, and the other end is fixed to the fixing portion 101f2 of the first panel 101.

First, the stored state A of the display apparatus 100 will be described with reference to FIG. 5A. In the stored state A of the display apparatus 100, the wire 103 fixed at the fixing portion 101e1 follows the groove portion 101b1, groove portion 101d1, and groove portion 101c1, comes into contact with (is routed by) the lower-side face and face B and left-side face of the first panel 101, and is fixed at the fixing portion 102f1. Also, in the stored state A of the display apparatus 100, the wire 104 fixed at the fixing portion 101e2 follows the groove portion 101b2, groove portion 101d2, and groove portion 101c2, comes into contact with the lower-side face and face B and left-side face of the first panel 101, and is fixed at the fixing portion 102f2. Also, in the stored state A of the display apparatus 100, the wire 105 fixed at the fixing portion 102e1 follows the groove portion 102b1, groove portion 102d1, and groove portion 102c1, comes into contact with the lower-side face and face B and right-side face of the second panel 102, and is fixed at the fixing portion 101f1. Also, in the stored state A of the display apparatus 100, the wire 106 fixed at the fixing portion 102e2 follows the groove portion 102b2, groove portion 102d2, and groove portion 102c2, comes into contact with the lower-side face and face B and right-side face of the second panel 102, and is fixed at the fixing portion 101f2.

Next, the lateral unfolded state of the display apparatus 100 will be described with reference to FIG. 5B. The wires are guided through the groves in the same way as with the above-described stored state A, so hereinafter, the differences between the lateral unfolded state and the stored state A will be described.

In the lateral unfolded state of the display apparatus 100, the wire 103 passes between the first panel 101 and the second panel 102 and heads to face A of the second panel 102. In the same way, the wire 105 passes between the first panel 101 and the second panel 102 and heads to face A of the first panel 101. Note that the term “between the first panel 101 and the second panel 102” refers to the space formed by both the groove portion 101c1 formed in the first panel 101 and the groove portion 102c1 formed in the second panel 102.

In the lateral unfolded state of the display apparatus 100, the wire 104 passes between the first panel 101 and the second panel 102 and heads to face A of the second panel 102. In the same way, the wire 106 passes between the first panel 101 and the second panel 102 and heads to face A of the first panel 101. Note that the term “between the first panel 101 and the second panel 102” refers to the space formed by both the groove portion 101c2 formed in the first panel 101 and the groove portion 102c2 formed in the second panel 102.

In the lateral unfolded state of the display apparatus 100, the portion of the wire 103 that passes over face B along the groove portion 101d1 (in contact with face B) will be referred to as “passing portion 103c”. The portion of the wire 104 that passes over face B along the groove portion 101d2 (in contact with face B) will be referred to as “passing portion 104c”. In the same way, the portion of the wire 105 that passes over face B along the groove portion 102d1 (in contact with face B) will be referred to as “passing portion 105c”, and the portion of the wire 106 that passes over face B along the groove portion 102d2 (in contact with face B) will be referred to as “passing portion 106c”.

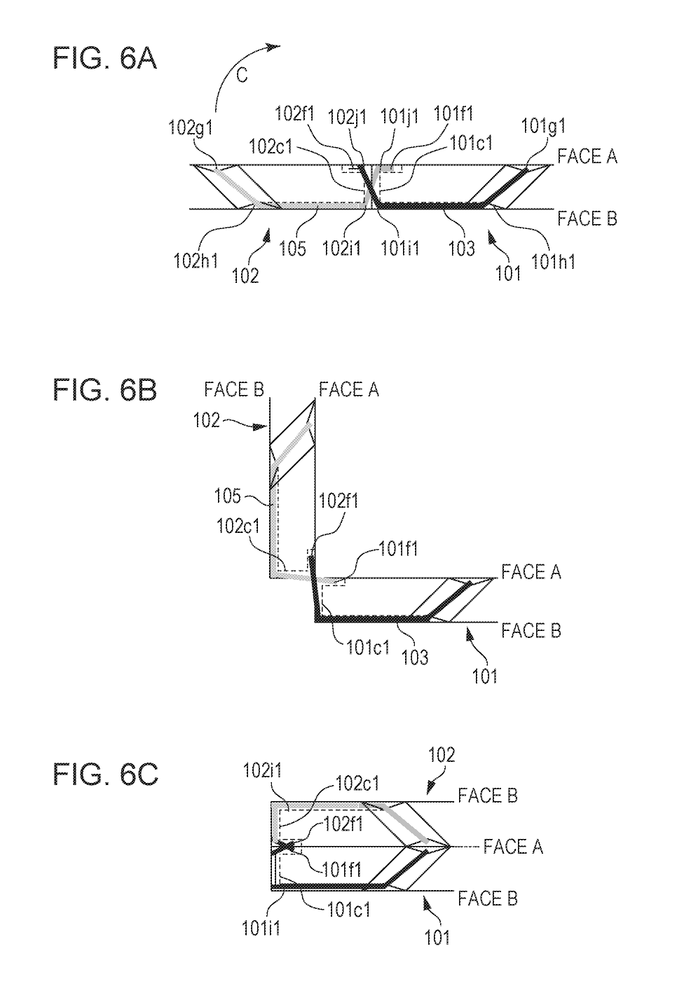

Note that in a case where the display apparatus 100 is in the lateral unfolded state, the wire 103 is in contact with at least the corners 101g1, 101h1, and 101i1 of the first panel 101, and corner 102j1 of the second panel 102. In a case where the display apparatus 100 is in the lateral unfolded state, the wire 104 is in contact with at least the corners 101g2, 101h2, and 101i2 of the first panel 101, and corner 102j2 of the second panel 102. Also, in a case where the display apparatus 100 is in the lateral unfolded state, the wire 105 is in contact with at least the corners 102g1, 102h1, and 102i1 of the second panel 102, and corner 101j1 of the first panel 101. Further, in a case where the display apparatus 100 is in the lateral unfolded state, the wire 106 is in contact with at least the corners 102g2, 102h2, and 102i2 of the second panel 102, and corner 101j2 of the first panel 101. This will be described in detail later with reference to FIGS. 6A through 6C.

The both-sided state of the display apparatus 100 will be described next with reference to FIG. 5C. In the both-sided state of the display apparatus 100, the wire 103 fixed at the fixing portion 101e1 follows the groove portion 101b1 and groove portion 102c1, comes into contact with the lower-side face of the first panel 101 and right-side face of the second panel 102, and is fixed at the fixing portion 102f1. Note that the wire 103 passes between the first panel 101 and the second panel 102 on face B of the first panel 101 and second panel 102. The term “between the first panel 101 and the second panel 102” refers to the space formed by both the groove portion 101d1 formed in the first panel 101 and the groove portion 102d1 formed in the second panel 102.

In the both-sided state of the display apparatus 100, the wire 104 fixed at the fixing portion 101e2 follows the groove portion 101b2 and groove portion 102c2, comes into contact with the lower-side face of the first panel 101 and right-side face of the second panel 102, and is fixed at the fixing portion 102f2. Note that the wire 104 passes between the first panel 101 and the second panel 102 on face B of the first panel 101 and second panel 102. The term “between the first panel 101 and the second panel 102” refers to the space formed by both the groove portion 101d2 formed in the first panel 101 and the groove portion 102d2 formed in the second panel 102.

In the both-sided state of the display apparatus 100, the wire 105 fixed at the fixing portion 102e1 follows the groove portion 102b1 and groove portion 101c1, comes into contact with the lower-side face of the second panel 102 and left-side face of the first panel 101, and is fixed at the fixing portion 101f1. Note that the wire 105 passes between the first panel 101 and the second panel 102 on face B of the first panel 101 and second panel 102, in the same way as the wire 103 described above.

In the both-sided state of the display apparatus 100, the wire 106 fixed at the fixing portion 102e2 follows the groove portion 102b2 and groove portion 101c2, comes into contact with the lower-side face of the second panel 102 and left-side face of the first panel 101, and is fixed at the fixing portion 101f2. The wire 106 also passes between the first panel 101 and the second panel 102 on face B of the first panel 101 and second panel 102, in the same way as the wire 104 described above.

Next, the longitudinal unfolded state of the display apparatus 100 will be described with reference to FIG. 5D. In the longitudinal state of the display apparatus 100, the wire 103 fixed at the fixing portion 101e1 follows the groove portion 102b1 and groove portion 102c1, comes into contact with face B and the right-side face of the second panel 102, and is fixed at the fixing portion 102f1. Note that the wire 103 passes between the first panel 101 and the second panel 102 on the lower-side face of the first panel 101 and second panel 102. The term “between the first panel 101 and the second panel 102” refers to the space formed by both the groove portion 101b1 formed in the first panel 101 and the groove portion 102b1 formed in the second panel 102.

In the longitudinal state of the display apparatus 100, the wire 104 fixed at the fixing portion 101e2 follows the groove portion 102d2 and groove portion 102c2, comes into contact with face B and the right-side face of the second panel 102, and is fixed at the fixing portion 102f2. Note that the wire 104 passes between the first panel 101 and the second panel 102 on the lower-side face of the first panel 101 and second panel 102. The term “between the first panel 101 and the second panel 102” refers to the space formed by both the groove portion 101d2 formed in the first panel 101 and the groove portion 102b2 formed in the second panel 102.

In the longitudinal state of the display apparatus 100, the wire 105 fixed at the fixing portion 102e1 follows the groove portion 101d1 and groove portion 101c1, comes into contact with face B and the left-side face of the first panel 101, and is fixed at the fixing portion 101f1. Note that the wire 105 passes between the first panel 101 and the second panel 102 on the lower-side face of the first panel 101 and second panel 102, in the same way as the wire 103 described above.

In the longitudinal state of the display apparatus 100, the wire 106 fixed at the fixing portion 102e2 follows the groove portion 101d2 and groove portion 101c2, comes into contact with face B and the left-side face of the first panel 101, and is fixed at the fixing portion 101f2. Note that the wire 106 passes between the first panel 101 and the second panel 102 on the lower-side face of the first panel 101 and second panel 102, in the same way as the wire 104 described above.

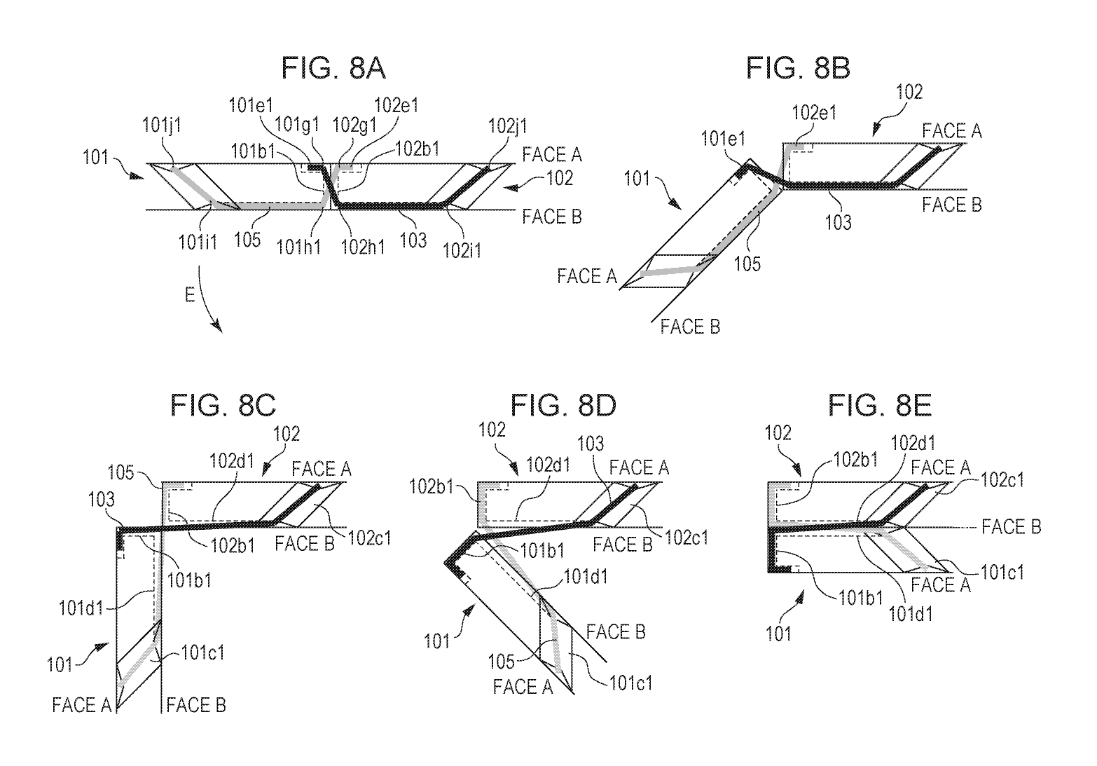

Note that in a case where the display apparatus 100 is in the longitudinal unfolded state, the wire 103 is in contact with at least the corners 102j1, 102i1, and 102h1 of the second panel 102, and corner 101g1 of the first panel 101. In a case where the display apparatus 100 is in the lateral unfolded state, the wire 104 is in contact with at least the corners 102j2, 102i2, and 102h2 of the second panel 102, and corner 101g2 of the first panel 101. Also, in a case where the display apparatus 100 is in the lateral unfolded state, the wire 105 is in contact with at least the corners 101j1, 101i1, and 101h1 of the first panel 101, and corner 102g1 of the second panel 102. Further, in a case where the display apparatus 100 is in the longitudinal unfolded state, the wire 106 is in contact with at least the corners 101j2, 101i2, and 101h2 of the first panel 101, and corner 102g2 of the second panel 102. This will be described in detail later with reference to FIGS. 8A through 8E.

Next, the stored state B of the display apparatus 100 will be described with reference to FIG. 5E. In the stored state B of the display apparatus 100, the wire 103 fixed at the fixing portion 101e1 follows the groove portion 102b1, groove portion 102d1, and groove portion 102c1, comes into contact with the lower-side face, face B, and right-side face of the second panel 102, and is fixed at the fixing portion 102f1. In the stored state B of the display apparatus 100, the wire 104 fixed at the fixing portion 101e2 follows the groove portion 102b2, groove portion 102d2, and groove portion 102c2, comes into contact with the lower-side face, face B, and right-side face of the second panel 102, and is fixed at the fixing portion 102f2. In the stored state B of the display apparatus 100, the wire 105 fixed at the fixing portion 102e1 follows the groove portion 101b1, groove portion 101d1, and groove portion 101c1, comes into contact with the lower-side face, face B, and left-side face of the first panel 101, and is fixed at the fixing portion 101f1. In the stored state B of the display apparatus 100, the wire 106 fixed at the fixing portion 102e2 follows the groove portion 101b2, groove portion 101d2, and groove portion 101c2, comes into contact with the lower-side face, face B, and left-side face of the first panel 101, and is fixed at the fixing portion 101f2.

As described above, the relative position of the first panel 101 and second panel 102 of the display apparatus 100 according to the present embodiment can be changed, to change to the above-described unfolded states and folded states. Specifically, the display apparatus 100 and be unfolded and folded in the order of, starting from the stored state A, the stored state A, the lateral unfolded state, the both-sided state, the longitudinal unfolded state, and the stored state B, or in the opposite order thereof. That is to say, the relative layout of the panels of the display apparatus 100 according to the present embodiment can be changed so that the adjacent sides of the panels are different.

While the wire 103 is guided through the groove portion 101d1 formed on face B of the first panel 101 in the lateral unfolded state of the display apparatus 100, the wire 103 is guided through the groove portion 102d1 formed on face B of the second panel 102 in the longitudinal unfolded state. The wires 104 through 106 also are guided through different groove portions depending on the unfolded state of the display apparatus 100, in the same way as the wire 103.

That is to say, the wires 103 through 106 according to the present embodiment are configured to move between grooves formed in the first panel 101 and grooves formed in the second panel 102 in accordance with the relative layout of the panels changing. According to this configuration, the display apparatus 100 according to the present embodiment can be changed to the above-described various states by changing the relative layout of the first panel 101 and second panel 102.

Other than nearby the fixing portions, the panels on which the wires 103 through 106 are overlaid in the direction orthogonal with face A and face B change (are interchanged) depending on whether the state of the display apparatus 100 is the lateral unfolded state or the longitudinal unfolded state. For example, in the lateral unfolded state of the display apparatus 100, the wire 103 is overlaid on the first panel 101 in the direction orthogonal with face A and face B, but overlaid on the second panel 102 in the longitudinal unfolded state. On the other hand, in the lateral unfolded state of the display apparatus 100, the wire 105 is overlaid on the second panel 102 in the direction orthogonal with face A and face B, but overlaid on the first panel 101 in the longitudinal unfolded state.

Note that the display apparatus 100 according to the present embodiment is configured such that the wires pass through the spaces formed between the first panel 101 and second panel 102 in the lateral unfolded state, both-sided state, and longitudinal unfolded state, as described above. At this time, the wire 103 and wire 105, and the wire 104 and wire 106, intersect each other in the above spaces. This point will be described in detail with reference to FIGS. 6A through 8E.

FIGS. 6A through 6C exemplarily illustrate a case of the state of the display apparatus 100, which is a display apparatus for carrying out aspects of the present invention, changing from the lateral unfolded state to the stored state A (folding). FIG. 6A is an enlarged view for exemplarily describing the lateral unfolded state of the display apparatus 100, as viewed from the lower-face side of the display apparatus 100. FIG. 6B is an enlarged view for exemplarily describing the transitional state of the display apparatus 100 from the lateral unfolded state to the stored state A, as viewed from the lower-face side of the display apparatus 100. FIG. 6B illustrates the display apparatus 100 in a state of the second panel 102 of having turned around 90 degrees relative to the first panel 101 from the state in FIG. 6A. FIG. 6C is an enlarged view for exemplarily describing the stored state A of the display apparatus 100, as viewed from the lower-face side of the display apparatus 100. FIG. 6C illustrates the display apparatus 100 in a state of the second panel 102 of having turned around 90 degrees relative to the first panel 101 from the state in FIG. 6B.

The movement of the wires 103 and 105 in a case of having changed the display apparatus 100 from the lateral unfolded state to the stored state A, in the direction of the arrow C in FIG. 6A, will be described with reference to FIGS. 6A through 6C. The movement of the wires 104 and 106 is generally the same as the movement of the wires 103 and 105, so description thereof will be omitted.

In the lateral unfolded state of the display apparatus 100, the wire 103 comes into contact with the corner 101g1 of the face A side which corresponds to the first side of the first panel 101 and the corner 101h1 of the face B, and the corner 101i1 of the face B which corresponds to the second side, as illustrated in FIG. 6A. The wire 103 is supported by the corner 101i1 of the first panel 101 and the corner 102j1 of face A which corresponds to the fourth side of the second panel 102. The wire 103 passes through the space formed between the groove portion 101c1 and the groove portion 102c1 in this state.

In the lateral unfolded state of the display apparatus 100, the wire 105 comes into contact with the corner 102g1 of the face A side which corresponds to the third side of the second panel 102 and the corner 102h1 of the face B, and the corner 102i1 of the face B which corresponds to the second side. The wire 105 is supported by the corner 102i1 at the face B side of the groove portion 102c1 of the second panel 102 and the corner 101j1 at the face A side which corresponds to the second side of the groove portion 101c1 of the first panel 101. The wire 105 passes through the space formed between the groove portion 101c1 and the groove portion 102c1 in this state.

As illustrated in FIG. 6A, the wire 103 and the wire 105 intersect in the space formed between the groove portion 101c1 in the first panel 101 and the groove portion 102c1 in the second panel 102. At this time, the wire 103 and wire 105 intersect around the middle between face A and face B of the first panel 101 and second panel 102.

Next, in the transitional state of the display apparatus 100 illustrated in FIG. 6B, the intersection position of the wire 103 and the wire 105 moves toward the face A side of the first panel 101 and the second panel 102 as the second panel 102 is being folded.

Next, in the stored state A of the display apparatus 100 illustrated in FIG. 6C, the wire 103 is supported by the fixing portion 102f1 of the second panel 102 and the corner 101i1 at the face A side of the groove portion 101c1 of the first panel 101. The wire 105 is supported by the fixing portion 101f1 of the first panel 101 and the corner 102i1 at the face A side of the groove portion 102c1 of the second panel 102.

As illustrated in FIG. 6C, in the stored state A of the display apparatus 100, the wire 103 and the wire 105 intersect between face A of the first panel 101 and face A of the second panel 102. Specifically, the wire 103 and the wire 105 intersect in the space formed by the grooves formed on face A of the first panel 101 and second panel 102.

As described above, the positions where the wires are supported change as the display apparatus 100 is folded from the lateral unfolded state to the stored state A. As the positions supporting the wires change, the position of intersection of the wires moves from the position between the face A and face B of the first panel 101 and second panel 102, to the face A side. According to this configuration, the display apparatus 100 can be folded without the wires falling out of their respective grooves.

Note than when changing the state of the display apparatus 100 from the stored state A to the lateral unfolded state (unfolding), the wires move in the opposite order as to the above-described movement. Further, the actions of transition of the display apparatus 100 from the longitudinal unfolded state to the stored state B, and transition of the display apparatus 100 from the stored state B to the longitudinal unfolded state, are the same as the above-described actions of transition from the lateral unfolded state to the stored state A and transition from the stored state A to the lateral unfolded state, so description will be omitted.

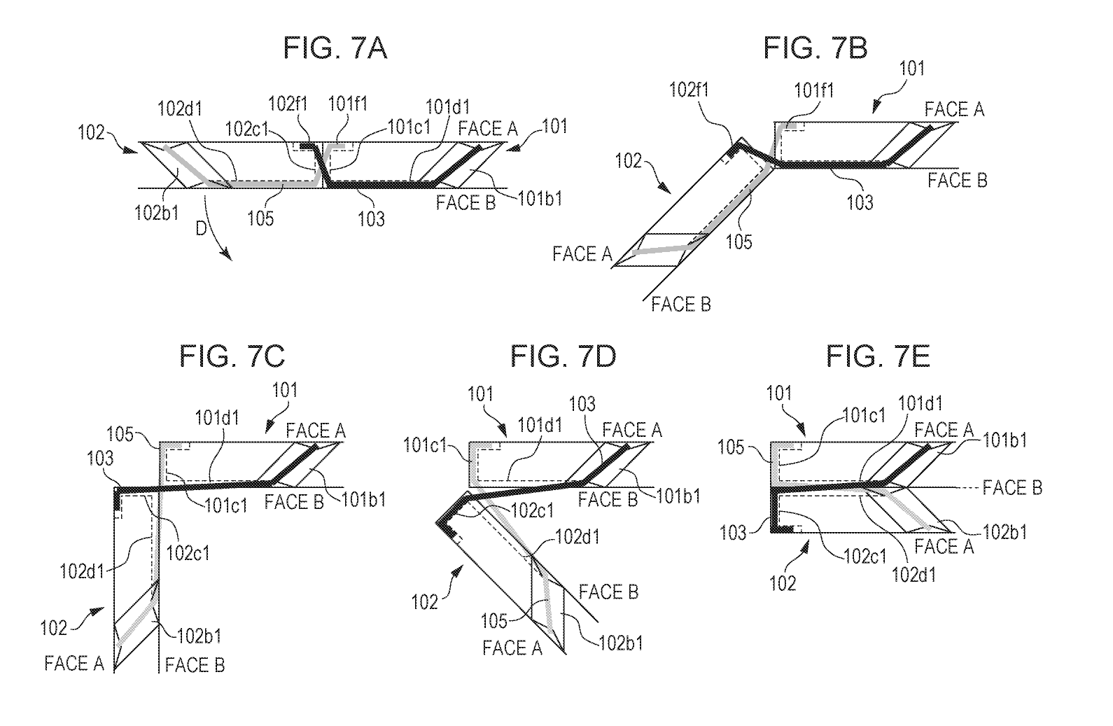

FIGS. 7A through 7E exemplarily illustrate a case of the state of the display apparatus 100, which is a display apparatus for carrying out aspects of the present invention, changing from the lateral unfolded state to the both-sided state. FIG. 7A is an enlarged view for exemplarily describing the lateral unfolded state of the display apparatus 100, as viewed from the lower-face side of the display apparatus 100. FIG. 7B is an enlarged view for exemplarily describing a transition state of the display apparatus 100 from the lateral unfolded state to the both-sided state, as viewed from the lower-face side of the display apparatus 100, illustrating a state of the second panel 102 of having turned around 45 degrees relative to the first panel 101 from the state in FIG. 7A. FIG. 7C is an enlarged view for exemplarily describing a transition state of the display apparatus 100 from the lateral unfolded state to the both-sided state, as viewed from the lower-face side of the display apparatus 100, illustrating a state of the second panel 102 of having turned around 90 degrees relative to the first panel 101 from the state in FIG. 7A. FIG. 7D is an enlarged view for exemplarily describing a transition state of the display apparatus 100 from the lateral unfolded state to the both-sided state, as viewed from the lower-face side of the display apparatus 100, illustrating a state of the second panel 102 of having turned around 135 degrees relative to the first panel 101 from the state in FIG. 7A. FIG. 7E is an enlarged view for exemplarily describing a transition state of the display apparatus 100 from the lateral unfolded state to the both-sided state, as viewed from the lower-face side of the display apparatus 100, illustrating a state of the second panel 102 of having turned around 180 degrees relative to the first panel 101 from the state in FIG. 7A.

The movement of the wires 103 and 105 in a case of having transitioned the display apparatus 100 from the lateral unfolded state to the both-sided state, in the direction of the arrow D in FIG. 7A, will be described with reference to FIGS. 7A through 7E. The movement of the wires 104 and 106 is generally the same as the movement of the wires 103 and 105, so description thereof will be omitted. Note that the direction of the arrow D in FIG. 7A is the opposite direction as to the direction of the arrow C in FIG. 6A.

The lateral unfolded state of the display apparatus 100 illustrated in FIG. 7A is the same as described above, so description will be omitted. Next, in the transitional state of the display apparatus 100 illustrated in FIG. 7B, the position of intersection of the wire 103 and wire 105 moves to face B of the first panel 101 and second panel 102 along with the folding of the second panel 102. Note that the positions where the wire 103 and wire 105 are supported at this time are generally the same as in the lateral unfolded state.

Next, in the transitional state of the display apparatus 100 illustrated in FIG. 7C, the wire 103 is supported at the A-face side end of the groove portion 102c1 of the second panel 102 and the B-face side end of the groove portion 101b1 of the first panel 101. The wire 105 is supported at the A-face side end of the groove portion 101c1 of the first panel 101 and the B-face side end of the groove portion 102b1 of the second panel 102. At this time, the position of intersection of the wire 103 and the wire 105 moves toward the neighborhood of the end of face B of the first panel 101 and second panel 102 in accordance with the folding of the second panel 102.

In the transitional state of the display apparatus 100 illustrated in FIG. 7D, the wire 103 is supported at the B-face side end of the groove portion 102c1 of the second panel 102 and the B-face side end of the groove portion 101b1 of the first panel 101. The wire 105 is supported at the B-face side end of the groove portion 101c1 of the first panel 101 and the B-face side end of the groove portion 102b1 of the second panel 102. In this state, the position of intersection of the wire 103 and the wire 105 moves to between face B of the first panel 101 and face B of the second panel 102 in accordance with the folding of the second panel 102. Note that in this state, the position of intersection is not situated in the space formed between the groove portion 101d1 and the groove portion 102d1.

Next, in the both-sided state of the display apparatus 100 illustrated in FIG. 7E, the wire 103 and wire 105 are supported at the same position illustrated in FIG. 7D, and intersect in the space formed between the groove portion 101d1 and the groove portion 102d1.

As described above, the positions where the wires are supported change as the display apparatus 100 is folded from the lateral unfolded state to the both-sided state. As the positions supporting the wires change, the position of intersection of the wires moves from the position between the face A and face B of the first panel 101 and second panel 102, to the face B side. According to this configuration, the state of the display apparatus 100 can be changed without the wires falling out of their respective grooves. Note than when changing the state of the display apparatus 100 from the both-sided state to the lateral unfolded state, the wires move in the opposite order as to the above-described movement.

FIGS. 8A through 8E exemplarily illustrate a case of the state of the display apparatus 100, which is a display apparatus for carrying out aspects of the present invention, changing from the lateral unfolded state to the both-sided state (folding). The drawings in FIGS. 8A through 8E are views of the display apparatus 100 from the left-side face (the right-side face of the second panel 102), from a direction where the display apparatus 100 has been rotated by 90 degrees, to match the description made above with reference to FIGS. 6A through 7E.

FIG. 8A is an enlarged view for exemplarily describing the longitudinal unfolded state of the display apparatus 100, as viewed from the left-face side of the display apparatus 100. FIG. 8B is an enlarged view for exemplarily describing a transition state of the display apparatus 100 from the longitudinal unfolded state to the both-sided state, as viewed from the left-face side of the display apparatus 100, illustrating a state of the first panel 101 of having turned around 45 degrees relative to the second panel 102 from the state in FIG. 8A. FIG. 8C is an enlarged view for exemplarily describing a transition state of the display apparatus 100 from the longitudinal unfolded state to the both-sided state, as viewed from the left-face side of the display apparatus 100, illustrating a state of the first panel 101 of having turned around 90 degrees relative to the second panel 102 from the state in FIG. 8A. FIG. 8D is an enlarged view for exemplarily describing a transition state of the display apparatus 100 from the longitudinal unfolded state to the both-sided state, as viewed from the left-face side of the display apparatus 100, illustrating a state of the first panel 101 of having turned around 135 degrees relative to the second panel 102 from the state in FIG. 8A. FIG. 8E is an enlarged view for exemplarily describing a transition state of the display apparatus 100 from the longitudinal unfolded state to the both-sided state, as viewed from the left-face side of the display apparatus 100, illustrating a state of the first panel 101 of having turned around 180 degrees relative to the second panel 102 from the state in FIG. 8A.

The movement of the wires 103 and 105 in a case of having changed the display apparatus 100 from the longitudinal unfolded state to the both-sided state, in the direction of the arrow E in FIG. 8A, will be described with reference to FIGS. 8A through 8E. The movement of the wires 104 and 106 is generally the same as the movement of the wires 103 and 105, so description thereof will be omitted.

In the longitudinal unfolded state of the display apparatus 100, the wire 103 comes into contact with the corner 102j1 of the face A side and corner 102i1 on face B which correspond to the fourth side of the second panel 102, and the corner 102h1 of the face B which corresponds to the third side, as illustrated in FIG. 8A. The wire 103 is supported by the corner 102h1 of the second panel 102 and the corner 101g1 of face A which corresponds to the first side of the first panel 101. The wire 103 passes through the space formed between the groove portion 101b1 and the groove portion 102b1 in this state.

In the longitudinal unfolded state of the display apparatus 100, the wire 105 comes into contact with the corner 101j1 of the face A side and corner 101i1 on face B which correspond to the second side of the first panel 101, and the corner 101h1 of the face B which corresponds to the first side. The wire 105 is supported by the corner 101h1 of the first panel 101 and the corner 102g1 of face A which corresponds to the third side of the second panel 102. The wire 103 passes through the space formed between the groove portion 101b1 and the groove portion 102b1 in this state.

As illustrated in FIG. 8A, the wire 103 and the wire 105 intersect in the space formed between the groove portion 101b1 in the first panel 101 and the groove portion 102b1 in the second panel 102. At this time, the wire 103 and wire 105 intersect around the middle between face A and face B of the first panel 101 and second panel 102.

Next, in the transitional state of the display apparatus 100 illustrated in FIG. 8B, the intersection position of the wire 103 and the wire 105 moves toward the face B side of the first panel 101 and the second panel 102 as the second panel 102 is being folded. The positions where the wire 103 and the wire 105 are supported at this time is generally the same as those in the longitudinal unfolded state of the display apparatus 100.

Next, in the transitional state of the display apparatus 100 illustrated in FIG. 8C, the wire 103 is supported at the A-face side end of the groove portion 101b1 of the first panel 101 and the B-face side end of the groove portion 102c1 of the second panel 102. The wire 105 is supported at the A-face side end of the groove portion 102b1 of the second panel 102 and the B-face side end of the groove portion 101c1 of the first panel 101. At this time, the position of intersection of the wire 103 and the wire 105 moves toward the neighborhood of the end of face B of the first panel 101 and second panel 102 in accordance with the folding of the second panel 102.

In the transitional state of the display apparatus 100 illustrated in FIG. 8D, the wire 103 is supported at the B-face side end of the groove portion 101b1 of the first panel 101 and the B-face side end of the groove portion 102c1 of the second panel 102. The wire 105 is supported at the B-face side end of the groove portion 102b1 of the second panel 102 and the B-face side end of the groove portion 101c1 of the first panel 101. In this state, the position of intersection of the wire 103 and the wire 105 moves to between face B of the first panel 101 and face B of the second panel 102 in accordance with the folding of the second panel 102. Note that in this state, the position of intersection is not situated in the space formed between the groove portion 101d1 and the groove portion 102d1.

Next, in the both-sided state of the display apparatus 100 illustrated in FIG. 8E, the wire 103 and wire 105 are supported at the same position illustrated in FIG. 8D, and intersect in the space formed between the groove portion 101d1 and the groove portion 102d1.

As described above, the positions where the wires are supported change as the state of the display apparatus 100 is changed from the longitudinal unfolded state to the both-sided state. As the positions supporting the wires change, the position of intersection of the wires moves from the position between the face A and face B of the first panel 101 and second panel 102, to the face B side. According to this configuration, the state of the display apparatus 100 can be changed without the wires falling out of their respective grooves. Note than when changing the state of the display apparatus 100 from the both-sided state to the longitudinal unfolded state, the wires move in the opposite order as to the above-described movement.

According to the configuration described above, the display apparatus 100 according to the present embodiment can be easily operated to assume any of the five states of the lateral unfolded state, both-sided state, stored state A, stored state B, and longitudinal unfolded state. Thus, the relative layout of the first panel 101 and second panel 102 of the display apparatus 100, that each have display units provided thereupon, can be changed to multiple states.

Accordingly, in a case of dividing a single image to be displayed on the first display unit 101a and the second display unit 102a, the display apparatus 100 according to the present embodiment allows the relative layout of the panels to be freely changed in accordance with the size of this single image, the type of shooting of the image, and so forth. For example, in a case where the ratio of length of the two orthogonal sides (e.g., long side and short side) of the display image to be displayed on the display apparatus 100 is a ratio often used in photography or by image sensor, such as 3:2 or 16:9, the state of the display apparatus 100 is changed to the longitudinal unfolded state. In a case where the ratio of length of the two orthogonal sides of the display image to be displayed on the display apparatus 100 is a horizontally-long ratio such as Scope size often used in movies, or so-called panorama images (e.g., a ratio of 2:1 or higher), the state of the display apparatus 100 is changed to the lateral unfolded state.

Thus, the user of the display apparatus 100 according to the present embodiment can change the relative layout of the panels in accordance with the ratio (aspect ratio) of the two orthogonal sizes of the display image. Accordingly, the display apparatus 100 can display the image in a maximal size on the display region obtained by combining the first display unit 101a of the first panel 101 and the second display unit 102a of the second panel 102, based on the aspect ratio of the display image, which is information relating to the display image. Particularly, in a case where the display apparatus 100 is applied to an imaging apparatus such as a digital camera or the like, the acquired using the imaging apparatus image can be displayed on the display apparatus 100 in a maximal size for each of different types of images having different ratios of the length of the sides.

Now, the display size of images (display images) on the first panel 101 and second panel 102 of the display apparatus 100 will be described. First, in a case where the display apparatus 100 is in the both-sided state (FIG. 5C), the display size of the display on the first display unit 101a and second display unit 102a is a length of Wd in the direction parallel to the long side of each the casing and a length of Hd in the direction parallel to the short side.

In a case where the display apparatus 100 is in the lateral unfolded state (FIG. 5B), the display region of the entire display apparatus 100 is the sum region of the first display unit 101a and second display unit 102a. Accordingly, in a case where the display apparatus 100 is in the lateral unfolded state, the above region can be deemed to be the display region of the display apparatus 100, and a display image can be displayed in this display region. In this case, the size of the display region is 2Wd wide and Hd high.

In the same way, in a case where the display apparatus 100 is in the longitudinal unfolded state (FIG. 5D), the sum region of the first display unit 101a and second display unit 102a can be deemed to be the entire display region of the display apparatus 100, and the size of the display region is Wd wide and 2Hd high.

That is to say, the display region of the display apparatus 100 according to the present embodiment in an unfolded state is twice the area of the display regions in the both-sided state. On the other hand, the display region of the display apparatus 100 in the both-sided state is half the area of the unfolded state. Thus, the display apparatus 100 according to the present embodiment can display large screen images while reducing the size of the apparatus itself in accordance with the state, so visibility of displayed images can be improved without sacrificing portability.

As described above, the display apparatus 100 according to the present embodiment can be changed to multiple states such as the stored states (A and B), lateral unfolded state, both-sided state, longitudinal unfolded state, and so forth. According to this configuration, the display apparatus 100 enables the relative layout of the panels to be freely changed in a case of dividing a single image to be displayed separately on the first display unit 101a and second display unit 102a, for example, based on the ratio of the long side and short side of the single image (display image).

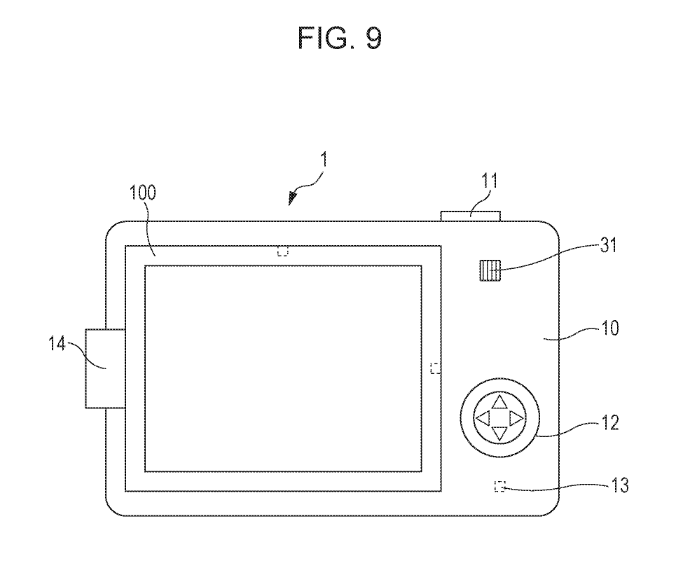

Now, a case where the display apparatus 100 has been applied to a display part of the camera 1 which is an imaging apparatus, will be described with reference to FIGS. 9 through 17. FIG. 9 is a diagram for describing the camera 1 according to the embodiment of the present invention. The camera 1 is configured including the above-described display apparatus 100, the camera body 10 that is an imaging unit, the hinge 14, and so forth. The rear side of the camera 1 according to the present embodiment is the side where the above-described display apparatus 100 is disposed, and the opposite side is the front side. The side where the hinge 14 that connects the camera 1 and the display apparatus 100 is the left side, and the opposite side is the right side.

The parts making up the camera body 10 will now be described. A release switch 11 is a part to instruct imaging preparation and imaging of a subject. Imaging preparation of the subject can be instructed by a half-press (SW1), and imaging of the subject can be instructed by a full-press (SW2).

An operation button 12 is an operating part that enables the drive mode and display mode of the camera 1 to be set. The operation button 12 is also used to change and adjust various types of parameters when performing imaging, changing images when performing reproduction of images, and so forth. A shooting mode for shooting subjects, and a reproduction mode for reproducing images, can be set as drive modes of the camera 1 according to the present embodiment.

An automatic display mode can also be set for the camera 1 according to the present embodiment, where the size of the display image is automatically change based on the state of the display apparatus 100. In this automatic display mode, a single display image can be divided and the images into which the single image has been divided can be separately displayed on the first display unit 101a and second display unit 102a.

At this time, the size of the display image to be displayed on the first display unit 101a and the second display unit 102a is changed in accordance with the relative layout of the first panel 101 and second panel 102. For example, in a case where the display apparatus 100 is in the lateral unfolded state, the display region of the display apparatus 100 is 2Wd wide and Hd high, so the size of the image to be divided and displayed on the display units is changed in accordance with the size of this display region. In a case where the display apparatus 100 is in the longitudinal unfolded state, the display region of the display apparatus 100 is Wd wide and 2Hd high, so the size of the image to be divided and displayed on the display units is changed in accordance with the size of this display region.

In the automatic display mode, the camera 1 according to the present embodiment can notify the user of the optimal state for the display apparatus 100 for the aspect ratio of the display image, based on the aspect ratio that is information relating to the display image. This will be described in detail later.

Other display modes that can be set for the camera 1 include a lateral display mode where the display image is displayed on the display units in accordance with the lateral unfolded state of the display apparatus 100, and a longitudinal display mode where the display image is displayed on the display units in accordance with the longitudinal unfolded state of the display apparatus 100. A further display mode of the camera 1 is a standard display mode where the display image is displayed on the display units in accordance with the both-sided state of the display apparatus 100.

An orientation detecting unit 13 is an orientation detection unit, such as acceleration sensors that detect the orientation of the camera 1. The later-described camera microprocessor 2 can detect the orientation of the camera 1 based on the detection results of the orientation detecting unit 13 in the present embodiment. Although the an arrangement is described in the present embodiment where the orientation detecting unit 13 is provided to the camera body 10 and used to detect the orientation of the camera 1, this is not restrictive. For example, an orientation detecting unit may be provided to the display apparatus 100, and the first CPU 110a or the like detect the orientation of the display apparatus 100 based on the detection results of this orientation detecting unit.

The hinge 14 is a connecting unit that connects the left side of the camera body 10 with the right side of the first panel 101 of the display apparatus 100, so that the display apparatus 100 can be relatively turned as to the camera body 10.

Although the hinge 14 according to the present embodiment has a turning axis parallel to the short side of the panels making up the display apparatus 100, this is not restrictive. A configuration may be made capable of turning on, in addition to this turning axis, an axis orthogonal to this turning axis and parallel to the long side of the panels of the display apparatus 100, thereby realizing so-called vari-angle operations.

A speaker 31 is an audio output unit that can output audio guidance, warnings, predetermined operating sounds, and so forth, relating to operation of the camera 1 and display apparatus 100, and is the notification unit in the present embodiment. This will be described in detail later.

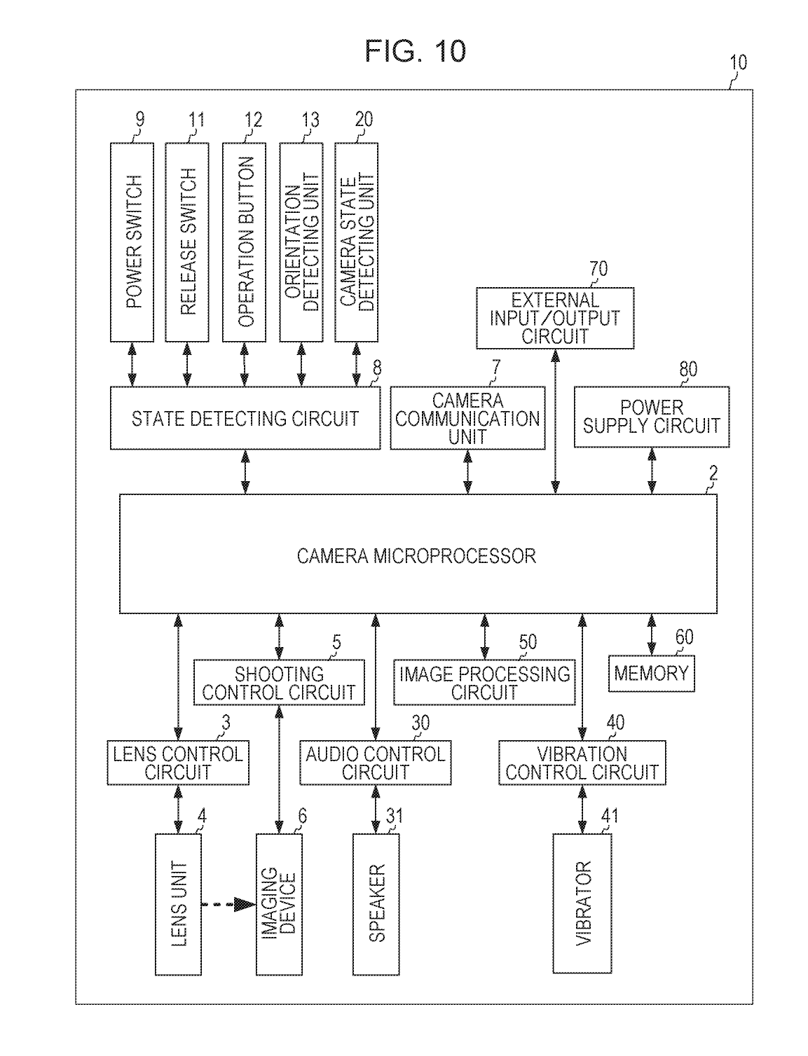

Next, the internal configuration of the camera body 10 will be described with reference to FIG. 10. FIG. 10 is a diagram for describing the internal configuration of the camera body 10 according to the embodiment of the present invention.

The camera microprocessor 2 is a control unit that centrally controls the operations of the camera 1. The components making up the camera 1 that are described below have their operations controlled in accordance with instructions from the camera microprocessor 2. The camera microprocessor 2 also is a determination unit that determines notification states of the display apparatus 100 (or camera 1), which will be described later.

A lens control circuit 3 is a driving controller that controls driving of a lens unit 4, controlling driving of a zoom lens, focusing lens, diaphragm, etc., that are omitted from illustration. Although the lens unit 4 according to the present embodiment is provided integrally with the camera body 10, a configuration may be made where the lens unit and the camera body 10 are provided separately.

A shooting control circuit 5 is a controller that controls the operations of an imaging device 6 (a charge accumulation type imaging device such as a complementary metal-oxide semiconductor (CMOS) device or the like) and driving of a shutter that is omitted from illustration, performing control relating to accumulation time control of the imaging device 6 and readout of accumulated charges. Note that the imaging device 6 performs photoelectric conversion of optical images of subjects input via the lens unit 4, and outputs analog image data.

The analog image data acquired using the imaging device 6 is converted into digital image data by an image processing circuit 50, and recorded in memory 60. This digital image data is subjected to processing by the image processing circuit 50 such as predetermined image interpolation, resizing processing, color conversion processing, pixel data computation processing regarding saturated pixels, underexposed pixels, and so forth, and thereafter the processed digital image data is converted into analog image data for display.

A state detecting circuit 8 is a state detecting unit that detects the states of various types of operating units disposed on the camera 1, such as switches and buttons, and the states of sensors and the like. For example, the state detecting circuit 8 can detect various states relating to the camera 1, such as detection results of the orientation detecting unit 13 and camera state detecting unit 20, operation of the operation button 12 by the user, and so forth.

A power switch 9 is a switch for instructing on/off of power for the camera body 10. Upon the state detecting circuit 8 detecting that the power switch 9 has been turned on, electric power is supplied to the various components of the camera body 10 from a power supply circuit 80. Electric power is also supplied to the various components of the display apparatus 100 from the first power unit 111 and second power unit 121.

Although the camera body 10 and display apparatus 100 according to the present embodiment are configured as having separate power sources, this is not restrictive. For example, if the camera body 10 and display apparatus 100 are electrically connected, a power source may be provided to one or the other of the camera body 10 and display apparatus 100, and supply power to the components making up the camera body 10 and display apparatus 100.

The camera state detecting unit 20 is a state detecting unit that detects the state of the camera 1. The camera state detecting unit 20 is made up of an electric contact 20a, and is provided to the camera body 10. The state of the camera 1 can be detected by detecting the conduction state between the electric contact 20a and the aforementioned electric contact 21a.

The camera 1 according to the present embodiment can detect the state of the camera 1 and the display apparatus 100 based on the detection results of the camera state detecting unit 20, and the aforementioned display state detecting units 21 and 22 at the display apparatus 100 side. Specifically, the state detecting circuit 8 can detect the state of the display apparatus 100 and the state of the camera 1 in accordance with the output from the electric contacts making up the display state detecting units 21 and 22 and the camera state detecting unit 20.

The camera communication unit 7 is a communication unit capable of communicating with the aforementioned first communication unit 112 and second communication unit 122 of the display apparatus 100. The camera microprocessor 2, first display control circuit 110, and second display control circuit 120 can communicate with each other via the camera communication unit 7, first communication unit 112, and second communication unit 122, in the present embodiment.

An audio control circuit 30 is a controller to control audio output from the speaker 31. A vibration control circuit 40 is a controller to control vibration actions of a vibrator (notification unit) 41. Note that the audio control circuit 30, speaker 31, vibration control circuit 40, and vibrator 41 may be of a configuration to be provided to the display apparatus 100.

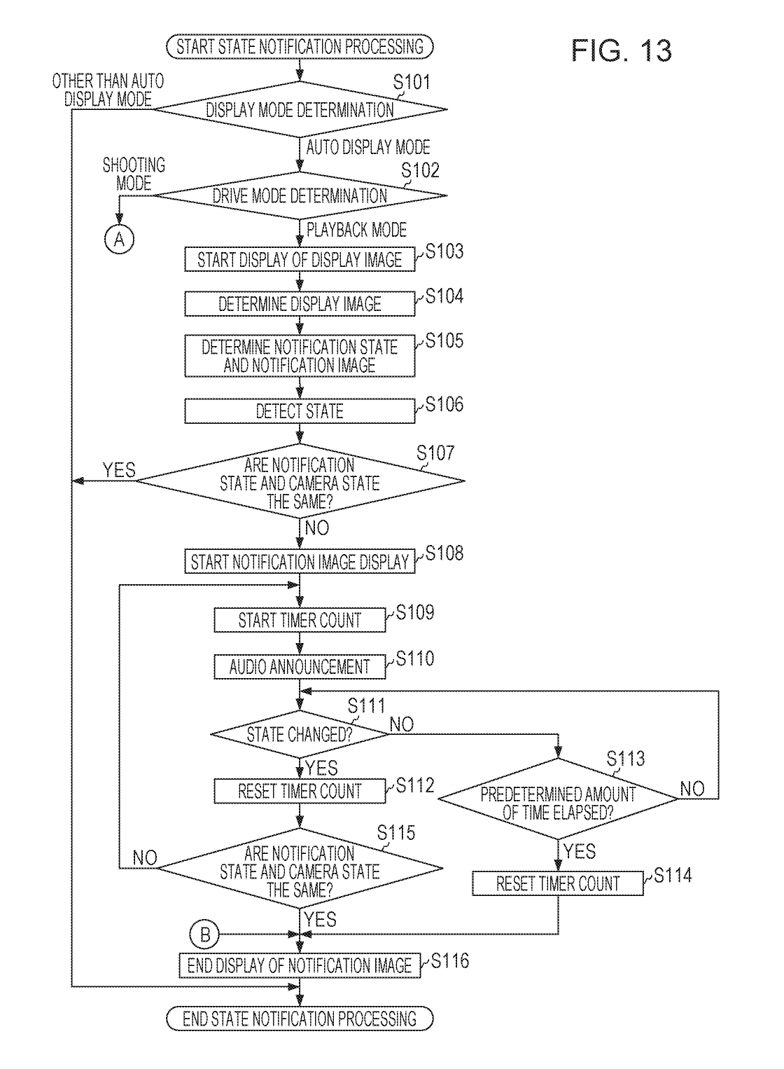

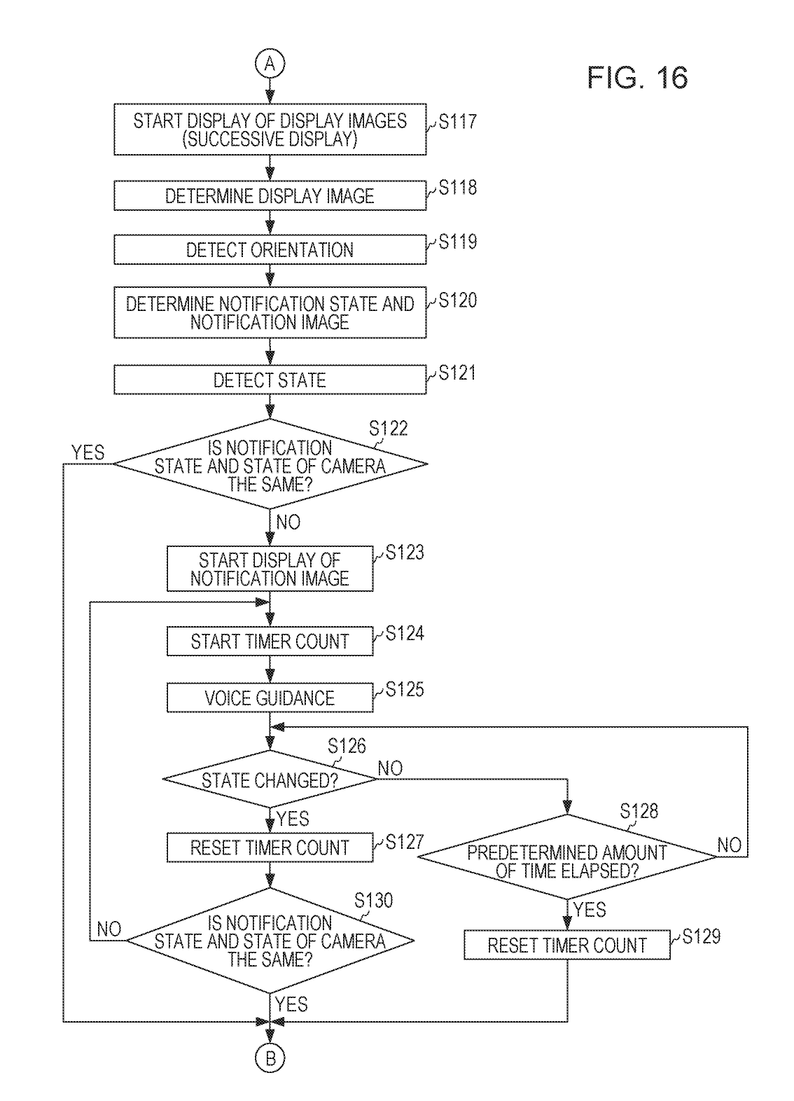

The memory 60 is electrically-erasable memory, storage, such as EEPROM of which flash memory and the like is representative, for example. The memory 60 stores various types of data used in the present embodiment. For example, programs executed in the camera 1, operational constants, various types of exposure conditions, calculation formulas used in the camera 1, program diagrams for setting the exposure conditions, light emission amount and light emission conditions and so forth for a light emission unit that is omitted from illustration, and so forth, are stored in the memory 60. Note that programs executed in the camera 1 are programs that instruct operations like the flowcharts illustrated in FIGS. 13 and 16, which will be described later.

The memory 60 can also record display images to be displayed on the display apparatus 100, and can record images transmitted externally to the camera 1 besides images acquired by imaging a subject using the camera 1. Memory for recording display images and other data and so forth may be provided separately. For example, a configuration may be made where display images are recorded in the memory 60 and the above-described various types of data may be stored in memory such as ROM, provided separately from the memory 60. Further, a configuration may be made where operations executed in the above-described memory 60 are executed in the first memory 110b and second memory 120b.

An external input/output circuit 70 is a communication control circuit that controls communication with external devices other than the camera 1, via an external cable or the like that is omitted from illustration. Information output from external devices is recorded in the memory 60. This so far has been a description of the internal configuration of the camera body 10 according to the present embodiment.

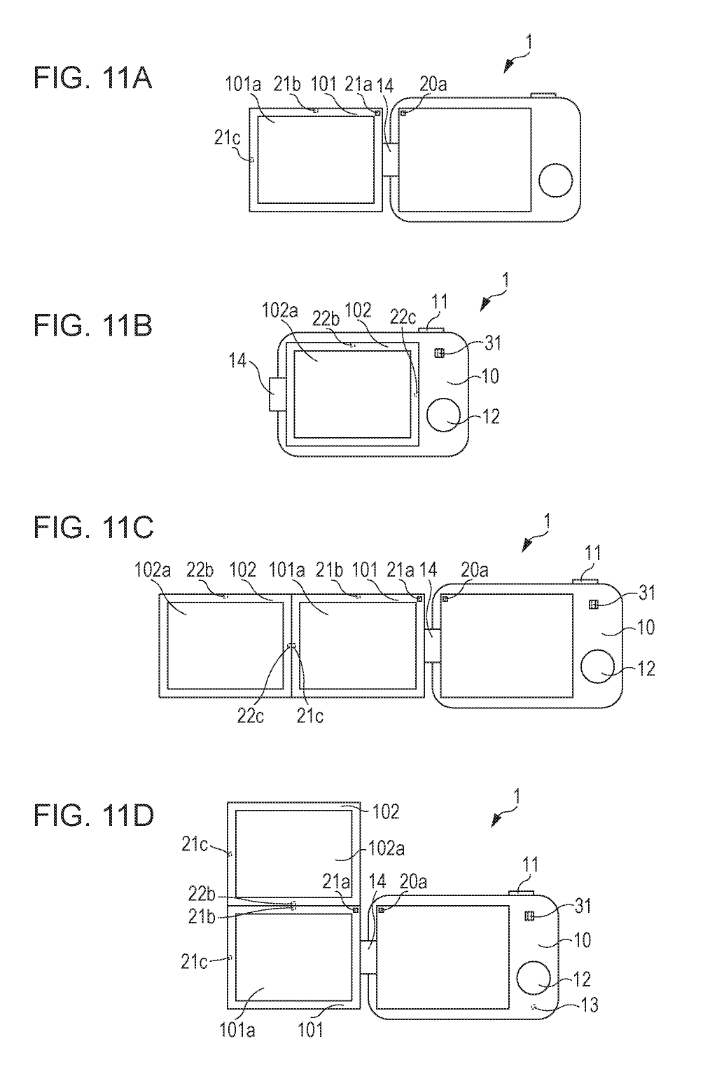

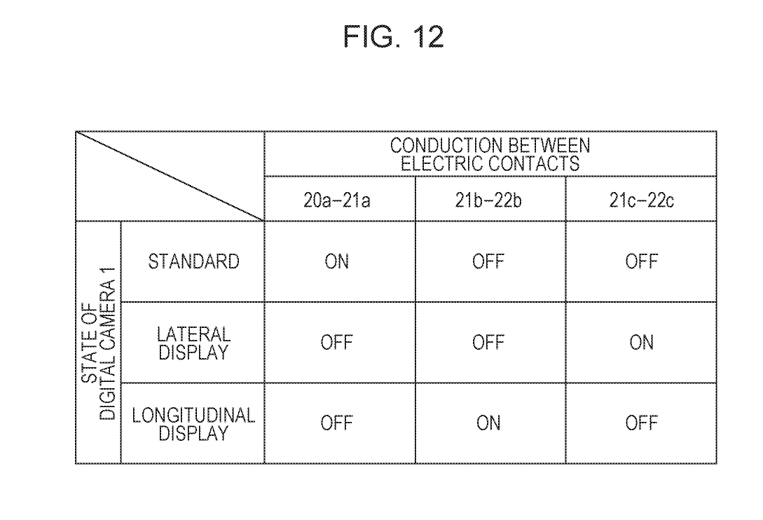

A method of detecting the state of the camera 1 and the state of the display apparatus 100 (the relative layout of the panels) will be described with reference to FIGS. 11A through 12. FIGS. 11A through 11D are diagrams for describing states of the camera 1 according to the embodiment of the present invention, and the positional relationship among the electric contacts of the display apparatus 100. FIG. 11A is a diagram exemplarily illustrating a state in which the display apparatus 100 is in the both-sided state and also the display apparatus 100 is not situated on the rear face of the camera body 10. FIG. 11B is a diagram exemplarily illustrating a state in which the display apparatus 100 is in the both-sided state and also the display apparatus 100 is situated on the rear face of the camera body 10 (hereinafter referred to as “standard state”). FIG. 11C is a diagram exemplarily illustrating a state in which the display apparatus 100 is in the lateral unfolded state and also the display apparatus 100 is not situated on the rear face of the camera body 10 (hereinafter referred to as “lateral display state”). FIG. 11D is a diagram exemplarily illustrating a state in which the display apparatus 100 is in the longitudinal unfolded state and also the display apparatus 100 is not situated on the rear face of the camera body 10 (hereinafter referred to as “longitudinal display state”).

The electric contact 20a is provided on the rear face side of the camera body 10 according to the present embodiment, at the upper left portion of the position where the display apparatus 100 is stored, as illustrated in FIG. 11A. The electric contact 21a is provided on the upper right edge of face A of the first panel 101, as illustrated in FIG. 11C. The electric contact 21b is provided near the middle of the upper-side face of the first panel 101. Further, the electric contact 21c is provided near the middle of the left-side face of the first panel 101. The electric contact 22b is provided near the middle of the upper-side face of the second panel 102, and further, the electric contact 22c is provided near the middle of the right-side face of the second panel 102.

The electric contacts described above are positioned so that one electric contact is adjacent to a corresponding another in any of the states of the camera 1 and the unfolded states of the display apparatus 100, so as to be in a conducting state with each other.

In a case where the camera 1 is in the standard state, the electric contact 20a overlays the electric contact 21a of the first panel 101 in the thickness direction of the camera (imaging direction), as illustrated in FIG. 11B, so the electric contact 20a and the electric contact 21a are in a conducting state.

In a case where the camera 1 is in the lateral display state (the display apparatus 100 is in the lateral unfolded state), the electric contact 21c is adjacent to the electric contact 22c of the second panel 102, as illustrated in FIG. 11C, so the electric contact 21c and the electric contact 22c are in a conducting state.

In a case where the camera 1 is in the longitudinal display state (the display apparatus 100 is in the longitudinal unfolded state), the electric contact 21b is adjacent to the electric contact 22b of the second panel 102, as illustrated in FIG. 11D, so the electric contact 21b and the electric contact 22b are in a conducting state.

FIG. 12 is a diagram for describing the states of the camera 1 according to the embodiment of the present invention, and the conduction states among the electric contacts. As illustrated in FIG. 12, in a case where conduction is detected between the electric contact 20a and electric contact 21a, and no conducting state is detected among the other electric contacts, the state detecting circuit 8 detects that the state of the camera 1 is the standard state.

Also, in a case where conduction is detected between the electric contact 21b and electric contact 22b, and no conducting state is detected among the other electric contacts as illustrated in FIG. 12, the state detecting circuit 8 detects that the state of the camera 1 is the lateral display state (the unfolded state of the display apparatus 100 is the lateral unfolded state).

In a case where conduction is detected between the electric contact 21c and electric contact 22c, and no conducting state is detected among the other electric contacts as illustrated in FIG. 12, the state detecting circuit 8 detects that the state of the camera 1 is the longitudinal display state (the unfolded state of the display apparatus 100 is the longitudinal unfolded state).

Next, state notification processing to notify the user with information relating to the state of the camera 1 (the state of the display apparatus 100, i.e., the relative layout of the panels) will be described with reference to FIGS. 13 through 17. FIG. 13 is a flowchart for describing state notification processing of the camera 1 according to the embodiment of the present invention. Note that information such as data acquired in the processes described below and so forth is recorded in the memory 60, and is read out by the camera microprocessor 2 as necessary.

The camera 1 according to the present embodiment is configured so that a display image is displayed on the display apparatus 100 in parallel with the state notification processing. That is to say, the camera 1 is configured so that a later-described state notification information image (hereinafter referred to as “notification image”) is displayed superimposed on the display image.

For example, when performing a so-called live view display in the shooting mode, where the imaging device 6 is used to consecutively display images acquired by periodically and continuously imaging a subject, the notification image can be displayed superimposed on this live view display. In the reproduction mode, the notification image can be displayed on the display apparatus 100, superimposed on a display image stored in the memory 60 that the user has specified for reproduction (display). Alternatively, a configuration may be made where superimposed display on other images is not performed, and only the notification image is displayed on the display apparatus 100.

Now, referencing FIG. 13, upon the state notification processing being started in accordance with the power switch 9 of the camera 1 having been turned on, in step S101 the camera microprocessor 2 determines the current display mode of the camera 1 based on the output signals from the state detecting circuit 8. The camera 1 according to the present embodiment is configured such that the state notification processing currently being performed is ended and new state notification processing is started in accordance with the drive mode being changed, the display image to be reproduced being changed, the aspect ratio of an acquired image in the shooting mode being changed, and so forth, not only when the power switch 9 is turned on. This will be described later in detail.

In a case where determination is made by the camera microprocessor 2 that the current display mode is other than the automatic display mode, the information notification processing ends. That is to say, in a case where determination is made that the display mode is the lateral display mode, longitudinal display mode, or standard display mode, the camera microprocessor 2 ends the information notification processing.

In a case where the camera microprocessor 2 determines that the display mode is the automatic display mode, in step S102 the camera microprocessor 2 determines the drive mode of the camera 1 based on the detection results of the state detecting circuit 8.

In a case where the camera microprocessor 2 determines that the current drive mode is the shooting mode, the flow advances to step S116, and state notification processing in the shooting mode is performed. This will be described in detail later.

In a case where the camera microprocessor 2 determines that the current drive mode is the reproduction mode, the flow advances to step S103. In step S103, the camera microprocessor 2 reads out image data recorded in the memory 60, and displays a display image on the display apparatus 100 corresponding to this image data, in a state where the image data has been subjected to various types of processing. While the display image to be displayed in the processing in step S103 is an image based on image data recorded last in the memory 60 as recorded image data in the present embodiment, a configuration may be made where other image data is displayed as a display image.

Next, in step S104 the camera microprocessor (image determining unit) 2 determines the ratio (aspect ratio) of the lengths of the two orthogonal sides of the display image displayed in step S103 (currently still displayed).

Next, in step S105 the camera microprocessor (determining unit) 2 determines the notification state of the display apparatus 100 based on the information (aspect ratio) relating to the display image that has been determined in step S104. Note that the notification state of the display apparatus 100 is the state of the display apparatus 100 whereby the display image can be displayed the largest, based on the aspect ratio of the display image. In step S105, the camera microprocessor (determining unit) 2 determines (generates) a notification image to be displayed on the display apparatus 100, based on the determined notification state. This processing will now be described in further detail.

In a case where the relative layout of the first panel 101 and the second panel 102 of the display apparatus 100 according to the present embodiment can be changed, and a single display image is to be divided and displayed, the optimal layout of the panels differs depending on the size of the display image, as described earlier. For example, the state of the display apparatus 100 by which the display image can be displayed the largest differs between a case of the ratio of length of the sides of the display image being a ratio often used in photography such as 3:2 or 16:9, and a case of 2:1 or higher such as in Scope size often used in movies, panorama images, and so forth.

However, in a case where the relative layout of the panels can be changed to multiple states as with the display apparatus 100 according to the present embodiment, it is difficult for the user to judge which layout of the panels is suitable for which ratio of sides (aspect ratio) of the display image. Accordingly, there are cases where unnecessarily time-consuming and complicated operations are necessary for the user to change the relative layout of the panels to put the display apparatus 100 in a state suitable for the aspect ratio of the display image.

The present embodiment addresses this by notifying, based on information relating to the display image, the user of procedures to change the relative position of the panels making up the display apparatus 100.

Returning to FIG. 13, in step S105 the camera microprocessor (determining unit) 2 determines the notification state of the display apparatus 100 depending on whether or not the aspect ratio of the display image is at a predetermined threshold value or higher. After determining the notification state, the notification image to be displayed superimposed on the display image is determined (generated), based on the information relating to the notification state. This notification image is an image relating to the relative layout of the first panel 101 and second panel 102 in the case of the present embodiment. This will be described in detail later.

The aspect ratio of the display image is the ratio of the length of the orthogonal sides of the display image. The length of the long side of the display image and the short side thereof is the aspect ratio of the display image in the present embodiment. The aspect ratio is calculated as shown in Expression (3)

A=L1/L2 (3)

where L1 represents the length of the long side of the display image, L2 represents the length of the short side, and A represents the aspect ratio of the display image.

The aforementioned predetermined threshold value Ash is Ash=2 in the present embodiment. This is a value that is about half the aspect ratio Aw=3 of the display area in the state of the display apparatus 100 being in the lateral unfolded state and the aspect ratio Ah=1.33 of the display area in the state of the display apparatus 100 being in the longitudinal unfolded state.

Accordingly, in the processing in step S105, the camera microprocessor 2 determines whether the aspect ratio A of the display image is the predetermined threshold value Ash or higher (A≧Ash), or smaller than the predetermined threshold value Ash (A<Ash). The camera microprocessor 2 then determines the relative layout of the first panel 101 and second panel 102 whereby the display image can be displayed the largest, based on the results of this determination, and generates a notification image based on that layout.

Although the present embodiment uses 2:1, which is an aspect ratio used for relatively wide-sized images such as so-called panorama images and Scope size images, this is not restrictive. A configuration may be made where other values are employed.

In a case where the aspect ratio of the display image is A≧2, the camera microprocessor 2 determines the lateral unfolded state for the notification state of the display apparatus 100. In a case where the aspect ratio of the display image is A<2, the camera microprocessor 2 determines the longitudinal unfolded state for the notification state of the display apparatus 100.

Next, in step S106 the camera microprocessor 2 determines the state of the camera 1 (and the state of the display apparatus 100), based on output signals from the state detecting circuit 8 based on the detection results from the camera state detecting unit 20 and display state detecting unit 22. The state of the camera 1 which can be determined in step S106 is one of the following three states, namely, the standard state, the lateral display state, and the longitudinal display state.

In step S107 the camera microprocessor 2 determines whether or not the state of the camera 1 detected in step S106 is the same as the notification state of the display apparatus 100 determined in step S105. That is to say, determination is made regarding whether or not the current relative layout of the panels is the same as the relative layout of panels to be notified by the notification image.

In a case where the camera microprocessor 2 determines that the notification state and the state of the camera 1 (or the display apparatus 100) are the same (Yes in step S107), the current state notification processing is ended.

Also, in a case where the camera microprocessor 2 determines that the notification state and the state of the camera 1 are not the same (No in step S107), The camera microprocessor 2 causes the notification image determined in step S105 to be displayed on the display apparatus 100. Specifically, the camera microprocessor 2 causes the notification image determined in step S105 to be displayed on the first display unit 101a and second display unit 102a.

Next, in step S109, the camera microprocessor 2 starts a timer count. Note that this timer count is an operation for measuring the amount of elapsed time after starting display of the current notification image displayed on the display apparatus 100.

Next, in step S110, the camera microprocessor 2 outputs audio guidance from the speaker 31, for prompting the user to change the state of the display apparatus 100, via the audio control circuit 30. This will be described in detail later.

In step S111, the camera microprocessor 2 next determines whether or not the state of the display apparatus 100 has been changed, based on the detection results of the state detecting circuit 8. That is to say, the camera microprocessor 2 determines whether or not the relative layout relationship between the first panel 101 and the second panel 102 of the display apparatus 100 has been changed.

In a case where determination is made by the camera microprocessor 2 that the state of the display apparatus 100 has been changed (Yes in step S111), in step S112 the camera microprocessor 2 resets the current timer count started in step S109. In a case where determination is made by the camera microprocessor 2 that the state of the display apparatus 100 has not been changed (No in step S111), in step S113 the camera microprocessor 2 determines whether or not the timer count started in step S109 has reached a predetermined amount of time.

In a case where the camera microprocessor 2 determines that the timer count has not reached the predetermined time (No in step S113), the flow returns to step S111 and the above-described processing is repeated. In a case where the camera microprocessor 2 determines that the timer count has reached the predetermined time (Yes in step S113), In step S144 the camera microprocessor 2 resets the current timer count started in step S109. The camera microprocessor 2 then in step S116 stops the display of the notification image currently being displayed, and the state notification processing ends.

In a case where the state of the display apparatus 100 is not changed even after the predetermined amount of time has elapsed from the start of display of the notification image (Yes in step S113), there is a good chance that the user does not want to change the state of the display apparatus 100. Accordingly, in a case where determination is made in the above-described step S113 that the predetermined amount of time has elapsed from the start of display of the notification image currently being displayed, display of the notification image is ended. At this time, only display of the notification image is ended; the display image remains displayed.

According to this configuration, a situation can be avoided in which unnecessary display of a notification image not intended by the user continues on the camera 1 according to the present embodiment. Although this predetermined time is 10 seconds in the present embodiment, an arrangement may be made where the predetermined time is other than 10 seconds.

Upon having reset the timer count in step S112, in step S115 the camera microprocessor 2 determines whether or not the notification state of the display apparatus 100 determined in step S105 and the state of the camera 1 after changing of the state are the same, in the same way as with the processing in step S107.

In a case where the camera microprocessor 2 determines that the notification state and the state of the camera 1 are not the same (No in step S115), the flow returns to step S109, and the above-described processing is repeated. The processing of steps S109 through S115 is repeated until determination is made that the state of the camera 1 and the notification state are the same.

In a case where determination is made by the camera microprocessor 2 that the content of display of the notification image and the state of the camera 1 are the same (Yes in step S115), in step S116 the camera microprocessor 2 ends display of the notification image currently being displayed, and the state notification processing ends. This so far has been description of the state notification processing in a case where the drive mode is the reproduction mode.

In the state notification processing in the reproduction mode, the current state notification processing is ended and new state notification processing is started in accordance with the display image to be reproduced being changed by a user operation or the like, as described above. The current state notification processing is ended and new state notification processing is started in accordance with the drive mode being changed by an user operation or the like, as well. For example, in a case where the user has changed the drive mode of the camera 1 from reproduction mode to shooting mode, the current state notification processing is ended and new state notification processing is started.

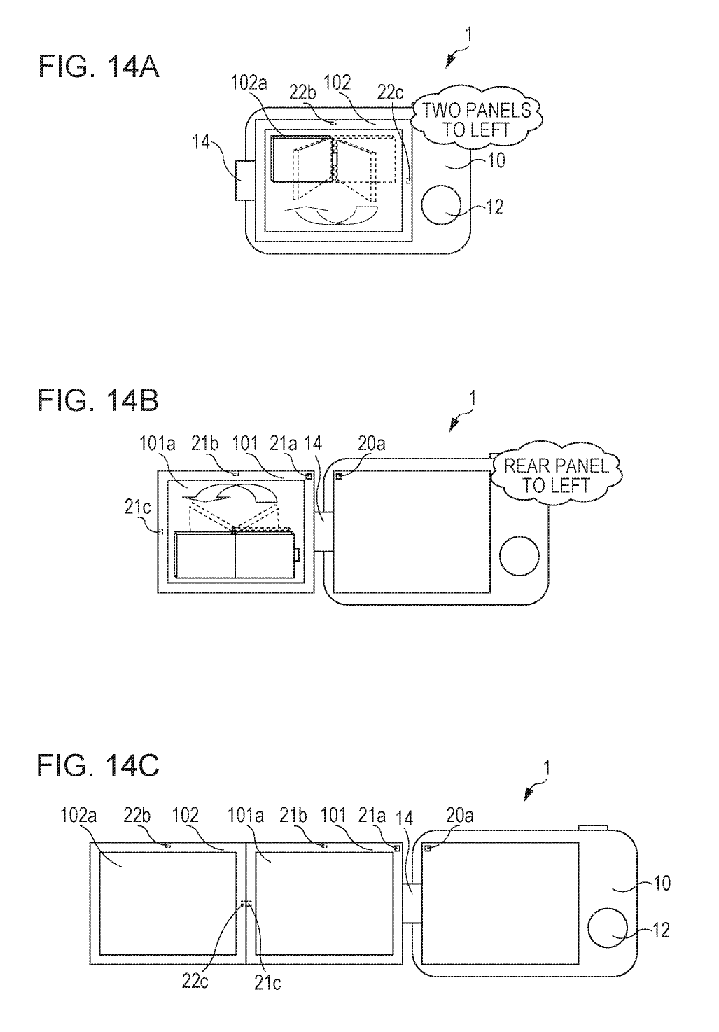

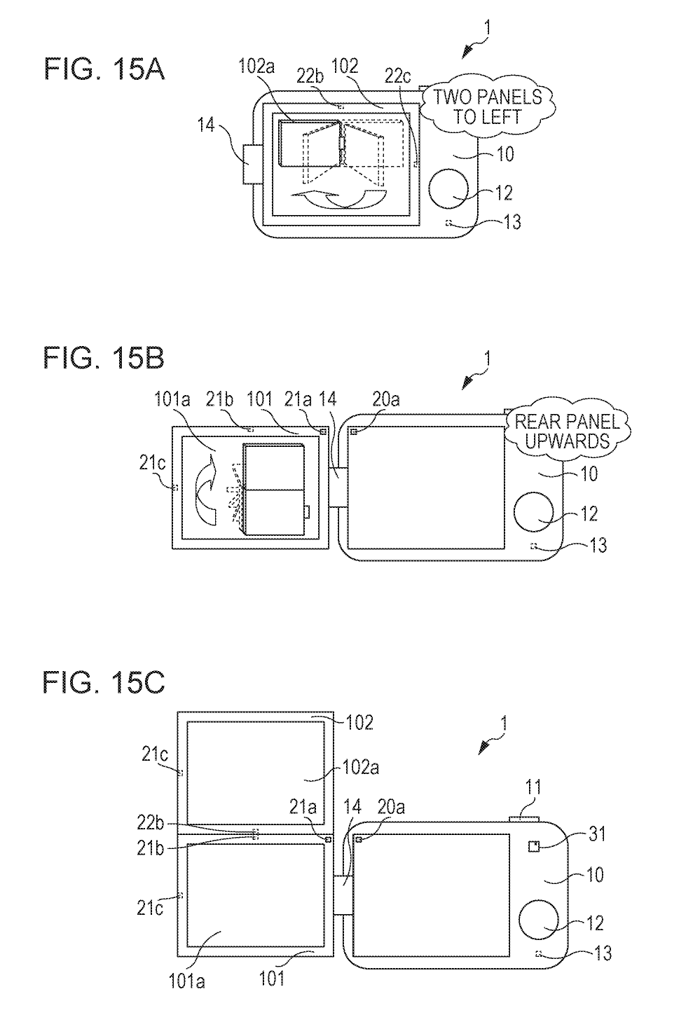

Display of the above notification image and audio guidance will be described in detail with reference to FIGS. 14A through 15C. FIGS. 14A through 14C are diagrams exemplarily illustrating display of a notification image relating to the laterally unfolded state of the display apparatus 100, and audio guidance, in state notification processing according to the embodiment of the present invention. FIGS. 15A through 15C are diagrams exemplarily illustrating display of a notification image relating to the longitudinal unfolded state of the display apparatus 100, and audio guidance, in state notification processing according to the embodiment of the present invention. That is to say, FIGS. 14A through 14C are drawings exemplarily describing state notification processing in a case where the aspect ratio A of the display image is smaller than 2, and FIGS. 15A through 15C are drawings exemplarily describing state notification processing in a case where the aspect ratio A of the display image is 2 or larger.

The drawings in FIGS. 14A through 15C are based on a case where the state of the camera 1 is the standard state. The states of the camera 1 illustrated in FIGS. 14A through 14C and FIGS. 15A through 15C each correspond to the processing of steps S107 through S115 in FIG. 13.

In a case where the notification state and the state of the camera 1 are not the same, display of the notification image by the display apparatus 100 and, and audio guidance by the speaker 31, are started as illustrated in FIG. 14A.

In the notification image according to the present embodiment, the layout of the panels in the current (before changing) and transitional states is displayed using dotted lines, and the layout of the panels after changing is displayed using solid lines (heavy lines). At the same time, the direction of change of the layout of the panels is displayed on the first display unit 101a and/or second display unit 102a using an arrow.

The audio guidance according to the present embodiment is configured to output information relating to the relative positional change of the first panel 101 and second panel 102 making up the display apparatus 100, such as “Two panels to left”.

FIG. 14B is a diagram exemplarily describing the camera 1 in a case where the state of the display apparatus 100 has been changed following the notification image and audio guidance illustrated in FIG. 14A. The content of the displayed notification image and the content of the audio guidance change in accordance with the state of the display apparatus 100 having been changed, as illustrated in FIG. 14B. Specifically, the camera microprocessor 2 changes the content of the displayed notification image and the content of the audio guidance to what is suitable for the display apparatus 100 after change, in accordance with change in the conduction state of the electric contacts having been detected due to the state of the display apparatus 100 having been changed.

FIG. 14C is a diagram exemplarily describing the camera 1 in a case where the state of the display apparatus 100 has been changed following the notification image and audio guidance illustrated in FIG. 14B. In a case where determination is made that the state of the display apparatus 100 and the notification state are the same, as illustrated in FIG. 14C, the display of the notification image and the audio guidance are ended.

In the state notification processing relating to the lateral unfolded state of the display apparatus 100, the display apparatus 100 situated on the rear face of the camera body 10 is turned to the right-side face direction of the camera body 10 while maintained in the both-sided display state (FIGS. 14A and 14B). Thereafter, the placement of the second panel 102 is changed relative to that of the first panel 101 by turning the second panel 102 on the short side (second side) of the first panel 101, thereby enabling the state of the display apparatus 100 to be changed to the lateral unfolded state (FIGS. 14B and 14C). The above-described operations enable the state of the camera 1 to be changed from the standard state to the lateral unfolded state.

A configuration may be made regarding the notification image, where the content of the notification image is not changed each time the state of the display apparatus 100 (the relative layout of the panels) is changed, with only the notification state of the display apparatus 100 determined earlier being displayed. That is to say, a configuration may be made where only information relating to the final state of the display apparatus 100 in accordance with the size of the display image is displayed. Any image may be used for the notification image according to the present embodiment, as long as it is capable of notifying the user of information relating to the relative layout of the panels.

Also, an electronic sound such as an alarm may be output from the speaker 31 as the audio guidance, in a case where the state of the notification state and the state of the display apparatus 100 are not the same.

Although a configuration has been described in the present embodiment where the notification image is displayed with priority on the display unit of a panel which faces the rear face side of the camera 1 and is capable of only minimal layout change, such as the first display unit 101a of in FIG. 14B, this is not restrictive. For example, a notification image may be displayed on both the first display unit 101a and the second display unit 102a.

In the state notification processing relating to the longitudinal unfolded state of the display apparatus 100, the first panel 101 and second panel 102 situated on the rear face of the camera body 10 are turned to the right-side face direction of the camera body 10 while maintained in the both-sided state (FIGS. 15A and 15B). Thereafter, the placement of the second panel 102 is changed relative to that of the first panel 101 by turning the second panel 102 on the long side (first side) of the first panel 101, thereby enabling the state of the display apparatus 100 to be changed to the longitudinal unfolded state (FIGS. 15B and 15C). The above-described operations enable the state of the camera 1 to be changed from the standard state to the longitudinal unfolded state.

The camera 1 according to the present embodiment is configured such that in a case where the notification state of the display apparatus 100 based on the aspect ratio of the display image is different from the current state of the display apparatus 100, the display units and speaker 31 and so forth are used to notify the user of information relating to procedures of changing the state of the display apparatus 100 to the notification state, as described above. The camera 1 is configured such that the notification is continued until the state of the display apparatus 100 is the same as the notification state.

According to this configuration, the user can easily tell the state of the display apparatus 100 corresponding to the size of the display image, in the reproduction mode of the camera 1, so the state of the display apparatus 100 can be speedily changed. Accordingly, the ease-of-use of the display apparatus, where the relatively layout of multiple panels each having display units can be changed, can be improved.

Next, the state notification processing in a case where the drive mode of the camera 1 is the shooting mode will be described with reference to FIG. 16. FIG. 16 is a flowchart for describing state notification processing in the shooting mode of the digital camera 1 according to the embodiment of the present invention. In a case where determination is made by the camera microprocessor 2 in step S102 that the current drive mode is the shooting mode, the camera 1 starts state notification processing for the shooting mode.

First, in step S117, the camera microprocessor 2 reads out image data recorded in the memory 60, and displays this image data on the display apparatus 100 as a display image. Note that unlike the processing of step S103 described above, the processing of step S117 involves displaying image data temporarily recorded in the memory 60 for successive display on the display apparatus 100 as a display image. This image data is consecutive image data accrued by consecutive shooting using the imaging device 6, and is unlike the recorded image data displayed in the reproduction mode.

Step S118 is the same processing as in step S104 described above, so description will be omitted. Next, in step S119 the camera microprocessor 2 detects the current orientation of the camera 1 based on the detection results of the orientation detecting unit 13. In a state where the rear face and side faces of the camera body 10 are generally parallel to the direction of gravity, the camera body 10 is turned on the photographing optical axis. If the angle of turning from this state is up to ±45°, the camera microprocessor 2 detects that the orientation of the camera 1 is the horizontal position. If the angle of turning from this where the rear face and side faces of the camera body 10 are generally parallel to the direction of gravity exceeds ±45°, the camera microprocessor 2 detects that the orientation of the camera 1 is the vertical position.

Next, in step S120 the camera microprocessor 2 determines the notification state of the display apparatus 100, based on the information relating to the aspect ratio of the display image that has been determined in step S118 and the information relating to the orientation of the camera 1 that has been detected in step S119. The camera microprocessor 2 then detects a notification image based on this notification state.

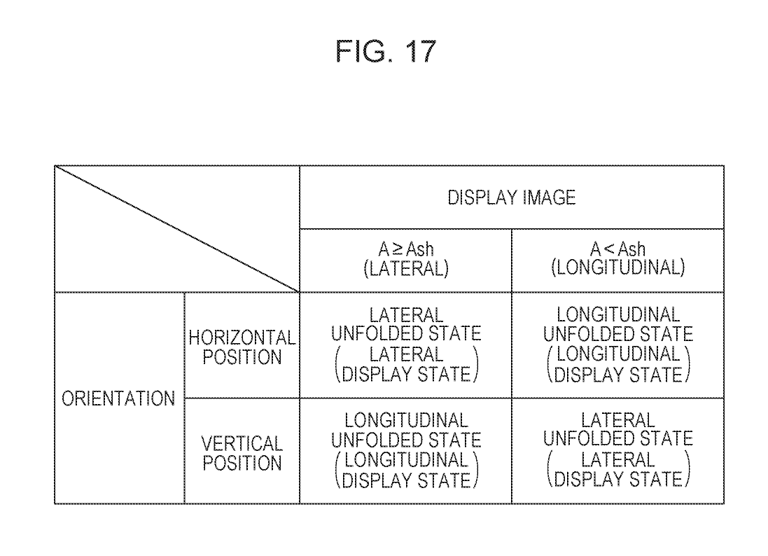

A method for determining the notification state in state notification processing in the shooting mode will be described with reference to FIG. 17. FIG. 17 is a diagram for describing the method of determining a notification state in the shooting mode of the camera 1 according to the embodiment of the present invention. The predetermined threshold value in the shooting mode is Ash=2, the same as in the reproduction mode.

FIG. 17 illustrates that in a case where the orientation of the camera 1 is the horizontal position and the aspect ratio of the display image is A Ash, the notification state relating to the display apparatus 100 is determined to be the lateral unfolded state of the display apparatus 100 (lateral display state of the camera 1). In a case where the orientation of the camera 1 is the horizontal position and the aspect ratio of the display image is A<Ash, the notification state relating to the display apparatus 100 is determined to be the longitudinal unfolded state of the display apparatus 100 (longitudinal display state of the camera 1).

FIG. 17 also illustrates that in a case where the orientation of the camera 1 is the vertical position and the aspect ratio of the display image is A≧Ash, the notification state relating to the display apparatus 100 is determined to be the longitudinal unfolded state of the display apparatus 100 (longitudinal display state of the camera 1). Further, in a case where the orientation of the camera 1 is the vertical position and the aspect ratio of the display image is A<Ash, the notification state relating to the display apparatus 100 is determined to be the lateral unfolded state of the display apparatus 100 (lateral display state of the camera 1).

That is to say, in a case where the display image is relatively wide sideways, and the camera 1 is in the horizontal position, the camera microprocessor 2 determines the notification state of the display apparatus 100 to be the lateral unfolded state. In a case where the display image is relatively wide sideways, and the camera 1 is in the vertical position, the camera microprocessor 2 determines the notification state of the display apparatus 100 to be the longitudinal unfolded state. Also, in a case where the display image is relatively long vertically, and the camera 1 is in the horizontal position, the camera microprocessor 2 determines the notification state of the display apparatus 100 to be the longitudinal unfolded state. In a case where the display image is relatively long vertically, and the camera 1 is in the vertical position, the camera microprocessor 2 determines the notification state of the display apparatus 100 to be the lateral unfolded state.

The subsequent steps S121 through S130 are generally the same as the processing in steps S106 through S116 described above, so description will be omitted. As described above, the current state notification processing is ended and new state notification processing is started in accordance to change in orientation of the camera 1, change in the display image, and so forth.

The aforementioned change in the display image in the reproduction mode means to change the display image being displayed (an image-feeding operation). On the other hand, change in the display image in the shooting mode means to change the aspect ratio of the display image currently being successively displayed. Change to the aspect ratio of the display image in the shooting mode is executed in accordance with the shooting settings of the camera 1 by the user.

Thus, according to the camera 1 of the present embodiment, the user can easily know the aspect ratio of a display image and the notification state of the display apparatus 100 that is suitable for the orientation of the camera 1, and procedures to change the state of the display apparatus 100 to this notification state, when in the shooting mode of the camera 1. Also, the camera 1 according to the present embodiment can notify the user of the state of the display apparatus 100 suitable for the aspect ratio of a display image (notification state), regardless of the drive mode, as described above.

According to this configuration, the user can change the state of the display apparatus 100 (or state of the camera 1) without hesitation, in accordance with the state of the display apparatus 100 that has been notified. Accordingly, the ease-of-use of the display apparatus, where the relatively layout of multiple panels each having display units can be changed, can be improved by employing the above-described configuration.

Aspects of the present invention are not restricted to the above-described exemplary embodiment. Various modifications and alterations may be made within the scope of these aspects. For example, a case has been described where the display apparatus 100 is applied as the display part of the camera 1 in the above embodiment, this is not restrictive. The display apparatus 100 may be applied to electronic equipment besides the camera 1. A configuration may also be made where the display apparatus 100 executes the above-described information notification processing in a standalone manner, without being connected to other electronic equipment.

In this case, a configuration may be made where the first display control circuit 110 and second display control circuit 120 carry out the processing that the above-described camera microprocessor 2, state detecting circuit 8, and so forth execute. For example, the first CPU 110a of the first display control circuit 110 and/or the second CPU 120a of the second display control circuit 120 may centrally control the processing of the display apparatus 100 as illustrated in the above-described FIGS. 13 and 16. Providing the display apparatus 100 with a speaker enables notification relating to the state of the display apparatus 100 to be executed using the speaker. In a case of executing information notification processing with the display apparatus 100 as a standalone, the first CPU 110a and/or the second CPU 120a serve as a determining unit to determine the notification state of the display apparatus 100.

Although description has been made in the above embodiment regarding a case of displaying a notification image using the display units and performing audio guidance using the speaker 31, as a method of notifying information relating to the relative layout of panels suitable for the aspect ratio of a display image, this is not restrictive. For example, a method of vibrating a vibrator 41 may be employed as a method of notifying information relating to the relative layout of panels suitable for the aspect ratio of a display image. This configuration will be described in detail. When the relative placement of the panels of the display apparatus 100 are changed by the user, the camera microprocessor 2 determines whether or not the notification state of the display apparatus 100 that has been determined earlier and the state of the display apparatus 100 that has been changed by the user are the same. In a case where the determination is made as a result of the determination by the camera microprocessor 2 that the state of the display apparatus 100 after having been changed and the notification state are not the same, the vibration control circuit 40 controls the vibrator 41 so as to vibrate. According to this configuration, the user can be notified more effectively whether the state of the display apparatus 100 to which he/she has changed is the same as the notification state of the display apparatus 100.

Also, although a case has been described in the above embodiment where the state of the display apparatus 100 (relative layout of the panels) suitable for the aspect ratio is determined based on the aspect ratio of a display image, as information relating to the display image, this is not restrictive. For example, a configuration may be made where the camera microprocessor 2 or the display control circuits do not reference the aspect ratio of the display image but rather reference only the lengths of the sides making up the display image, and determine the state of the display apparatus 100 suitable for the lengths of the sides. Alternatively, a configuration may be made where the camera microprocessor 2 or the display control circuits determine the state of the display apparatus 100 based on the number of pixels making up the display image in the vertical direction and horizontal direction. That is to say, the information relating to the display image that is used to determine the notification state of the display apparatus 100 is not restricted to the aspect ratio of the display image, and any information may be used as long as it relates to the length of the sides making up the display image.

Although a configuration has been described in the above embodiment where state notification processing is performed only in a case where the display mode is set to the automatic display mode, this is not restrictive. For example, a configuration may be made where the above-described state notification processing is executed in a case where the lateral display mode or longitudinal display mode is set as the display mode of the camera 1. That is to say, a configuration may be made where state notification processing is performed even in a case where the display mode is set to other than the automatic display mode.

In addition to the methods for notifying the state of the display apparatus 100 that have been described above, a configuration may be made where a light-emission device such as a lamp or the like is provided to the display apparatus 100 or camera body 10, for example, and notify the state of the display apparatus 100 by lighting or blinking of the light-emission device.

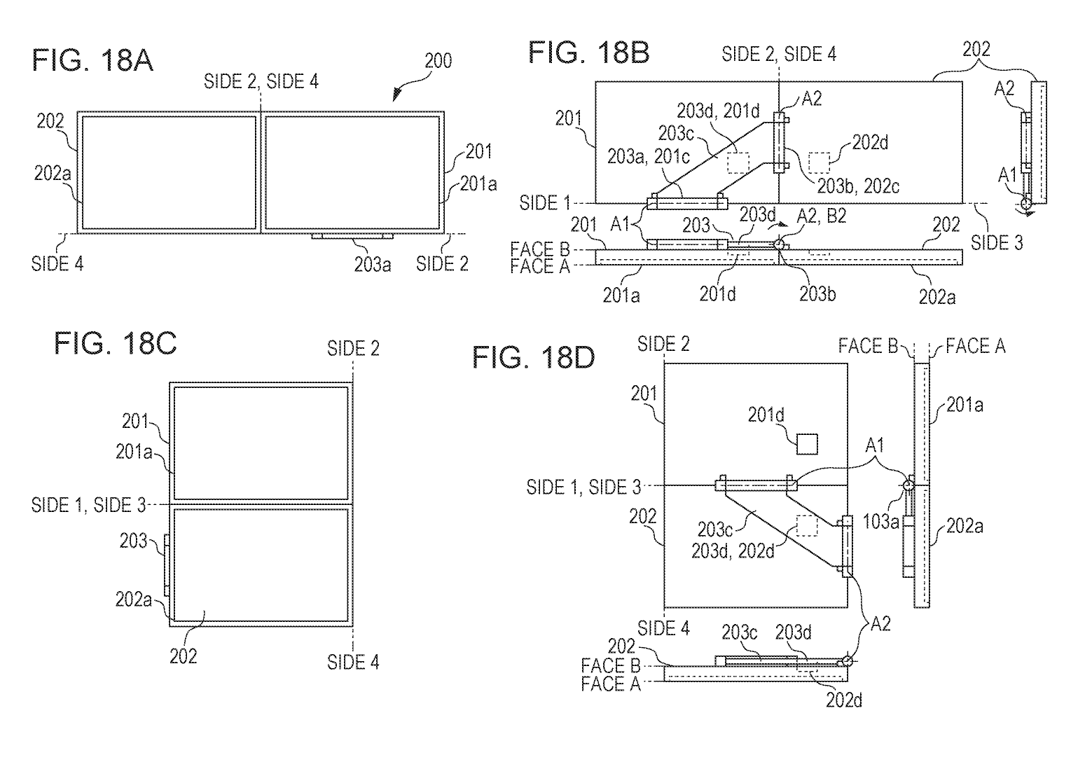

Also, while the display apparatus 100 according to the present embodiment described above has a configuration that employs connecting members made up of multiple wires, thereby connecting the first panel 101 and the second panel 102, this is not restrictive. For example, a configuration may be made where plate-shaped connecting units formed of a metal material are employed, as illustrated in FIGS. 18A through 18D.

FIGS. 18A through 18D are diagrams for describing a display apparatus 200 according to an embodiment of the present invention. FIG. 18A is a frontal view of the display apparatus 200 in the lateral unfolded state. FIG. 18B is a three-view plan centered on a rear view of the display apparatus 200 in the lateral unfolded state. FIG. 18C is a frontal view of the display apparatus 200 in the longitudinal unfolded state. Further, FIG. 18D is a three-view plan centered on a rear view of the display apparatus 200 in the longitudinal unfolded state. Note that in FIGS. 18A through 18D, the electric contacts of the display state detecting unit and camera state detecting unit are omitted from illustration, to facilitate description.

The display apparatus 200 is configured including a first panel 201 having a first display unit 201a, a second panel 202 having a second display unit 202a, and a hinge 203 connecting the panels, as illustrated in FIGS. 18A through 18D. The configuration of the panels and the display units thereof is the same as in the embodiment described above, and accordingly will be omitted. Configurations that differ from the embodiment described above will be described below.

The hinge 203 is a connecting member that is formed of a metal material and is plate-shaped. A hinge end 203a has a hollow cylinder shape centered on a turning axis (first axis) A1, and engages a shaft 201c of the first panel 201 so as to be turnable. A hinge end 203b has a hollow cylinder shape centered on a turning axis (second axis) A2, and engages a shaft 202c of the second panel 202 so as to be turnable.

The hinge 203 has the hinge end 203a turnably held at the edge of face B of the first panel 201, and the hinge end 203b turnably held at the edge of face B of the second panel 102. That is to say, the hinge 203 is a connecting member that us turnable in the directions indicated by the arrows in FIG. 18B, on the axis A1 and axis A2. Note that the axis A1 and axis A2 are orthogonal on the same plane.

Magnets 201d, 202d, and 203d are retainers disposed on the face B of the first panel 201 and second panel 202, and a linking region 203c of the hinge 203. The magnet which attracts the magnet 203d changes depending to the change in state of the display apparatus 200. For example, in a case where the display apparatus 200 is in the lateral unfolded state, the magnet 203d and the magnet 201d attract, and the hinge 203 is retained at the first panel 201. In a case where the display apparatus 200 is in the longitudinal unfolded state, the magnet 203d and the magnet 202d attract, and the hinge 203 is retained at the second panel 202.

The display apparatus 200 also can be changed to the lateral unfolded state where the first display unit 201a and second display unit 202a face generally the same direction and the side 3 of the second panel 202 exists on an extension of the side 1 of the first panel 201, as illustrated in FIGS. 18A and 18B. The display apparatus 200 further can be changed to the longitudinal unfolded state where the first display unit 201a and second display unit 202a face generally the same direction and the side 4 of the second panel 202 exists on an extension of the side 2 of the first panel 201, as illustrated in FIGS. 18C and 18D.

That is to say, the display apparatus 200 illustrated in FIGS. 18A through 18D is are capable of changing relative layout of the housings holding the display units, in the same way as the display apparatus 100 in the above-described embodiment. Accordingly, in a case where this display apparatus 200 is applied to the configuration of the embodiment described above, the user can easily know the state of the display apparatus 100 suitable for a display image, thereby improving ease-of-use of the display apparatus 200.

The display apparatus 200 has a configuration where the panels are provided with power source, and communication between the panels is realized by wireless communication, in the same way as with the display apparatus 100 described in the above embodiment, but this is not restrictive. For example, a configuration may be made where a flexible printed circuit board or the like that comes into contact electrically with the first panel 201 and the second panel 202 is disposed following the hinge 203, with communication and power exchange among the panels being performed through the flexible printed circuit board. In this case, costs of the display apparatus 200 can be suppressed, since a power supply unit and display control circuit needs to be provided to just one of the panels.

According to aspects of the present invention, the display apparatus is capable of at least changing the shape of a display region formed by display units by changing the relative layout of the housings as described above.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-074496, filed Mar. 31, 2015, which is hereby incorporated by reference herein in its entirety.

What is claimed is:

1. A display apparatus in which a relative layout of a plurality of panels, each panel having a display unit, can be changed, the display apparatus comprising:
a determination unit configured to determine, based on information relating to a display image to be displayed on the display units, the relative layout of the plurality of panels; and
a notification unit that performs notification of information relating to the relative layout of the plurality of panels that the determining unit has determined.

2. The display apparatus according to claim 1,
wherein the information relating to a display image is information relating to a length of a side of the display image.

3. The display apparatus according to claim 2,
wherein the information relating to a display image is information relating to a ratio of lengths of two orthogonal sides of the display image,
and wherein the determining unit determines the relative layout of the plurality of panels suitable for a ratio of the length of two orthogonal sides of the display image.

4. The display apparatus according to claim 1,
wherein, in a case of dividing a single display image so as to be displayed on the display units provided to the plurality of panels, in a state where the display units provided to the plurality of panels are facing in a same direction, the determining unit determines the relative layout of the plurality of panels so that the display image can be displayed in a maximal size on a display region which is a sum of the display units.

5. The display apparatus according to claim 4,
wherein the relative layout of the plurality of panels can be changed between a first state and a second state in which different sides of the plurality of panels are adjacent to each other in a state where the display units provided to the plurality of panels are facing in the same direction, and
wherein, in a case of dividing a single display image so as to be displayed on the display units provided to the plurality of panels, the determining unit determines, of the plurality of panels from the first state and the second state, a state in which the divided display image can be displayed as the largest on the display region as the relative layout of the plurality of panels.

6. The display apparatus according to claim 4,
wherein the display image is an image being displayed in a state where the display units are not facing the same direction.

7. The display apparatus according to claim 4,
wherein the display image is the single image to be displayed on the display region.

8. The display apparatus according to claim 1,
wherein, in a state of notifying information relating to the relative layout of the plurality of panels, the notification unit changes content being notified as information relating to the relative layout of the plurality of panels in accordance with the relative layout of the plurality of panels having been changed.

9. The display apparatus according to claim 1, further comprising:
a state detecting unit configured to detect the relative layout of the plurality of panels.
wherein, in a case where the relative layout of the plurality of panels that the state detecting unit has detected is the same as the relative layout of the plurality of panels that the determining unit has determined, the notification unit does not perform notification relating to the relative layout of the plurality of panels.

10. The display apparatus according to claim 1,
wherein in accordance with a predetermined amount of time having elapsed after having started notification of information relating to the relative layout of the plurality of panels, the notification unit stops performing notification of information relating to the relative layout of the plurality of panels.

11. The display apparatus according to claim 1,
wherein the determining unit determines, based on information relating to the display image after having been changed a new relative layout of the plurality of panels in accordance with the display image having been changed, and
wherein the notification unit changes, based on the relative layout of the plurality of panels determined by the determining unit, the content of notification in accordance with the display image having been changed.

12. The display apparatus according to claim 1,
wherein the notification unit notifies procedures to change the state of the display apparatus to the relative layout of the plurality of panels that the determining unit has determined, as information relating to the relative layout of the plurality of panels.

13. The display apparatus according to claim 1,
wherein the notification unit performs notification of information relating to the relative layout of the plurality of panels, by displaying, on the display units, a predetermined image relating to the relative layout of the plurality of panels that the determining unit has determined.

14. The display apparatus according to claim 1,
wherein the notification unit performs notification of information relating to the relative layout of the plurality of panels by performing predetermined audio guidance relating to the relative layout of the plurality of panels that the determining unit has determined.

15. The display apparatus according to claim 1, further comprising:
an orientation detecting unit configured to detect an orientation of the display apparatus,
wherein the determining unit determines the relative layout of the plurality of panels based on information relating to a size of the display image and information relating to the orientation of the display apparatus that the orientation detecting unit has detected.

16. The display apparatus according to claim 15, further comprising:
an imaging unit,
wherein the orientation detecting unit detects, as the orientation of the display apparatus, whether an imaging position of a subject using the imaging unit is a vertical position or a horizontal position.

17. The display apparatus according to claim 1, further comprising:
a connecting member configured to connect the plurality of panels so that the relative layout of the plurality of panels can be changed.

18. The display apparatus according to claim 17,
wherein the plurality of panels includes
a first panel having a first side and a second side orthogonal to the first side and having the display unit on a first face, and
a second panel having a third side and a fourth side orthogonal to the third side and having the display unit on a second face,
wherein the relative layout of the first panel and second panel of the display apparatus can be changed to assume at least
a first state where the second side and the fourth side are adjacent, with the first face and the second face facing a same direction, and
a second state where the first side and the third side are adjacent, with the first face and the second face facing a same direction.

19. A control method of a display apparatus in which a relative layout of a plurality of panels, each panel having a display unit, can be changed, the method comprising:
determining, based on information relating to a display image to be displayed on the display units, the relative layout of the plurality of panels; and
providing notification of information relating to the relative layout of the determined plurality of panels.
